(19) United States
(12) Patent Application Publication
(10) Pub. No.: US 2017/0249934 A1
(43) Pub. Date: Aug. 31, 2017

(54) ELECTRONIC DEVICE AND METHOD FOR OPERATING THE SAME

(71) Applicant: Samsung Electronics Co., Ltd., Suwon-si (KR)

(72) Inventors: Doosuk KANG, Suwon-si (KR); Kyungtae KIM, Hwaseong-si (KR); Yongjoon JEON, Hwaseong-si (KR); Minkyung HWANG, Seoul (KR); Hyelim WOO, Suwon-si (KR); Namkoo LEE, Suwon-si (KR); Jimin LEE, Suwon-si (KR)

(21) Appl. No.: 15/438,141

(22) Filed: Feb. 21, 2017

(30) Foreign Application Priority Data
Feb. 25, 2016 (KR) 10-2016-0022381

(51) Int. Cl. G10L 13/08; G06F 3/16; G06F 17/27

(52) U.S. Cl. CPC G10L 13/08; G06F 17/271; G06F 3/167; G06F 17/2785

(57) ABSTRACT

An electronic device is provided. The electronic device includes at least one communication circuit, a display, a speaker, a memory, and a processor electrically connected to the communication circuit, the display, the memory and the speaker. The processor is configured to receive a message that includes one or more items of a link or content through the at least one communication circuit, parse the message in order to recognize the one or more items, extract or receive content from the one or more items or from an external resource related to the one or more items, convert the message into at least one of a speech, a sound, an image, a video, and data according to at least one of the parsed message and the extracted or received content, and provide at least one of the speech, the sound, the image, the video, and the data to the speaker or the at least one communication circuit.

### CROSS-REFERENCE TO RELATED APPLICATION(S)

This application claims the benefit under 35 U.S.C. §119(a) of a Korean patent application filed on Feb. 25, 2016 in the Korean Intellectual Property Office and assigned Serial number 10-2016-0022381, the entire disclosure of which is hereby incorporated by reference.

### TECHNICAL FIELD

The present disclosure relates to an electronic device and a method for operating the same.

### BACKGROUND

With the development of speech signal processing technology, an electronic device can convert information to be transferred to a user into a speech to provide the converted speech to the user in eyes-free situation (e.g., during exercising) where the user does not see the electronic device. For example, in the case of receiving a notification in the eyes-free situation, the electronic device can provide speech information for notifying the user of the reception of the notification.

The above information is presented as background information only to assist with an understanding of the present disclosure. No determination has been made, and no assertion is made, as to whether any of the above might be applicable as prior art with regard to the present disclosure.

### SUMMARY

For example, if a notification (e.g., message) is confirmed, an electronic device may convert at least a part of text information that is included in the notification into a speech to provide the converted speech to a user. For example, in the case of receiving a message that includes letters or symbols like URL information, the electronic device can convert the letters or symbols into a speech and provide the speech to a user. In this case, at least a part of the speech being provided may be information that is meaningless to the user or information that is difficult to be understood.

Aspects of the present disclosure are to address at least the above-mentioned problems and/or disadvantages and to provide at least the advantages described below. Accordingly, an aspect of the present disclosure is to provide an apparatus and method for generating information that is meaningful to a user.

In accordance with an aspect of the present disclosure an apparatus for an electronic device is provided. The electronic device includes meaningful speech information to a user on the basis of a notification at least partly.

In accordance with another aspect of the present disclosure, an electronic device is provided. The electronic device includes at least one communication circuit, a display, a speaker, a memory, and a processor electrically connected to the at least one communication circuit, the display, the memory and the speaker. The processor configured to receive a message that includes one or more items of a link or content through the at least one communication circuit, parse the message in order to recognize the one or more items, extract or receive content from the one or more items or from an external resource related to the one or more items, convert the message into at least one of a speech, a sound, an image, a video, and data according to at least one of the parsed message and the extracted or received content, and provide at least one of the speech, the sound, the image, the video, and the data to the speaker or the at least one communication circuit.

In accordance with another aspect of the present disclosure, a method for operating an electronic device is provided. The method includes receiving, by the electronic device that includes at least one communication circuit, a display, and a speaker, a message that includes one or more items of a link or content through the at least one communication circuit, parsing the message in order to recognize the one or more items, extracting or receiving content from the one or more items or from an external resource related to the one or more items, converting the message into at least one of a speech, a sound, an image, a video, and data according to at least one of the parsed message and the extracted or received content, and providing at least one of the speech, the sound, the image, the video, and the data to the speaker or the at least one communication circuit.

In accordance with another aspect of the present disclosure an electronic device is provided. The electronic device includes, if a URL or content is included in a notification, enabling a user to recognize additional information even through only hearing of a speech by regenerating the URL or content as meaningful text information and providing the regenerated text information through the speech.

In accordance with another aspect of the present disclosure an electronic device is provided. The electronic device includes, in the case of a notification that includes an URL, generating meaningful information, such as a moving image, music, a title, or a summary of contents, and can provide the information through a speech, so that a user can understand the contents of the notification even through only hearing of the speech.

In accordance with another aspect of the present disclosure, an electronic device is provided. The electronic device includes regenerating information that is included in a notification as information that can be easily recognized by a user and is meaningful to the user, and can provide the regenerated information to the user.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device in a network environment according to an embodiment of the present disclosure;

FIG. 2 is a block diagram of an electronic device according to an embodiment of the present disclosure;

FIG. 3 is a block diagram of a program module according to an embodiment of the present disclosure;

FIG. 4 is a block diagram of an electronic device according to an embodiment of the present disclosure;

FIG. 5 is a diagram explaining the operations of an input processing module and an input device of an electronic device according to an embodiment of the present disclosure;

FIG. 6 is a flowchart explaining the operation of a natural language processing module according to an embodiment of the present disclosure;

FIG. 7 is a block diagram of a natural language understanding module according to an embodiment of the present disclosure;

FIGS. 8A and 8B are diagrams explaining the operation of a natural language understanding module according to various embodiments of the present disclosure;

FIG. 9 is a diagram illustrating a process of processing a notification in an electronic device according to an embodiment of the present disclosure;

FIG. 10 is a diagram illustrating a notification management module of an electronic device according to an embodiment of the present disclosure;

FIG. 11 is a flowchart illustrating a method for regenerating a notification in an electronic device according to an embodiment of the present disclosure;

FIG. 12 is a diagram illustrating an example of a notification that is received by an electronic device according to an embodiment of the present disclosure;

FIG. 13 is a diagram illustrating an example in which an electronic device regenerates a notification according to an embodiment of the present disclosure;

FIG. 14 is a diagram illustrating an example of a notification that includes a URL according to an embodiment of the present disclosure;

FIG. 15 is a diagram illustrating an example of a notification that is regenerated by an electronic device according to an embodiment of the present disclosure;

FIG. 16 is a flowchart illustrating a process of processing a notification that includes a URL according to an embodiment of the present disclosure;

FIG. 17A is a diagram illustrating an example of additional information that an electronic device can acquire from a URL according to an embodiment of the present disclosure;

FIG. 17B is a diagram illustrating an example of a web page that corresponds to a URL address according to an embodiment of the present disclosure;

FIG. 18 is a diagram illustrating an example in which an electronic device regenerates a notification that includes a URL according to an embodiment of the present disclosure;

FIG. 19 is a diagram illustrating an example in which an electronic device acquires additional information on the basis of the contents of a notification and history information according to an embodiment of the present disclosure;

FIG. 20 is a flowchart illustrating an operation of an electronic device that provides a speech service through determination of validity of the speech service of a received notification in the case where the electronic device receives the notification according to an embodiment of the present disclosure;

FIG. 21 is a diagram illustrating an example of the result of determination through which an electronic device determines validity of a speech service of a notification that is received by the electronic device according to an embodiment of the present disclosure;

FIG. 22 is a diagram illustrating an example of a notification that is regenerated by an electronic device according to an embodiment of the present disclosure;

FIG. 23 is a flowchart illustrating a processing procedure when a notification that includes a URL is received according to an embodiment of the present disclosure;

FIG. 24 is a diagram illustrating an example in which an electronic device acquires additional information using information that is included in a URL according to an embodiment of the present disclosure;

FIG. 25 is a diagram illustrating an example in which an electronic device regenerates a notification based on at least a part of information of a web page that corresponds to a URL according to an embodiment of the present disclosure; and

FIG. 26 is a diagram illustrating an example in which an electronic device provides a speech service that is set on the basis of the contents of a notification according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, operation, element, component, or combination thereof described in a specification and does not exclude presence or addition of at least one other characteristic, numeral, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate various embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a moving picture experts group layer-3 audio (MP3) player, a portable medical device, a digital camera, or a wearable device (e.g., an head-mounted device (HMD)) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a television (TV), a digital versatile disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., magnetic resonance angiography (MRA)), magnetic resonance imaging (MRI), computed tomography (CT), ultrasonography, etc.), a navigation device, a global positioning system (GPS) receiver, an event data recorder (EDR), an flight data recorder (FDR), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are not to be considered as a limitation of this disclosure.

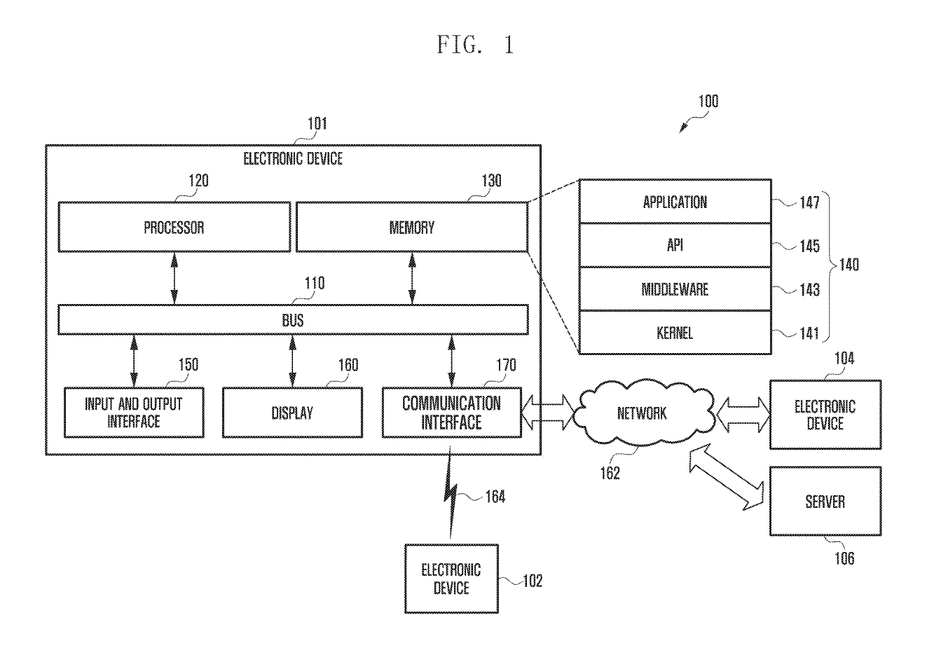

FIG. 1 is a block diagram 100 illustrating an electronic apparatus according to an embodiment of the present disclosure.

Referring to FIG. 1, the electronic apparatus 101 may include a bus 110, a processor 120, a memory 130, a user input module 150, a display 160, and a communication interface 170.

The bus 110 may be a circuit for interconnecting elements described above and for allowing a communication, e.g. by transferring a control message, between the elements described above.

The processor 120 can receive commands from the above-mentioned other elements, e.g. the memory 130, the user input module 150, the display 160, and the communication interface 170, through, for example, the bus 110, can decipher the received commands, and perform operations and/or data processing according to the deciphered commands.

The memory 130 can store commands received from the processor 120 and/or other elements, e.g. the user input module 150, the display 160, and the communication interface 170, and/or commands and/or data generated by the processor 120 and/or other elements. The memory 130 may include software and/or programs 140, such as a kernel 141, middleware 143, an application programming interface (API) 145, and an application 147. Each of the programming modules described above may be configured by software, firmware, hardware, and/or combinations of two or more thereof.

The kernel 141 can control and/or manage system resources, e.g. the bus 110, the processor 120 or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic apparatus 101.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic apparatus 101 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The user input module 150 can receive, for example, a command and/or data from a user, and transfer the received command and/or data to the processor 120 and/or the memory 130 through the bus 110. The display 160 can display an image, a video, and/or data to a user.

The communication interface 170 can establish a communication between the electronic apparatus 101 and other electronic devices 102 and 104 and/or a server 106. The communication interface 170 can support short range communication protocols, e.g. a Wireless Fidelity (WiFi) protocol, a BlueTooth (BT) protocol, and a near field communication (NFC) protocol, communication networks, e.g. Internet, local area network (LAN), wide area network (WAN), a telecommunication network, a cellular network, and a satellite network, or a plain old telephone service (POTS), or any other similar and/or suitable communication networks, such as network 162, or the like. Each of the electronic devices 102 and 104 may be a same type and/or different types of electronic apparatus.

In various embodiments of the present disclosure, the memory 130, when operated, may store instructions to cause the processor to receive a notification that includes a text and at least one link item or content item through a communication module, to parse the notification in order to recognize the text and the at least one item, to extract or receive content from the at least one item or from an external resource related to the at least one item, to convert the notification into a speech, a sound, an image, a video, and/or data on the basis of the parsed notification and/or the extracted or received content, and to provide at least one of the speech, the sound, the image, the video, and/or the data to the speaker or the at least one communication module.

In various embodiments of the present disclosure, the memory 130, when operated, may store instructions to cause the processor 120 to extract, if the at least one content item includes a video file or an audio file, at least a part of speech information that is included in the video file or the audio file, and to provide the extracted speech to the speaker.

In various embodiments of the present disclosure, the memory 130, when operated, may store a software program through which the processor 120 manages the notification that is received from an outside of the electronic device, and the software program may include at least the instruction part.

In various embodiments of the present disclosure, the memory 130, when operated, may store a software program through which the processor 120 functions as an agent which receives a user input and performs a function or provides a response in accordance with the user input, and the software program may include the instruction part.

An electronic device according to various embodiments of the present disclosure may include at least one communication circuit; a display; a speaker; a processor electrically connected to the communication circuit, the display, and the speaker; and a memory electrically connected to the processor. The memory, when executed, may store instructions to cause the processor to receive a message that includes one or more items of a link or content through the communication circuit, to parse the message in order to recognize the one or more items, to extract or receive content from the one or more items or from an external resource related to the one or more items, to convert the message into at least one of a speech, a sound, an image, a video, and data on the basis of at least one of the parsed message and the extracted or received content, and to provide the at least one of the speech, the sound, the image, the video, and the data to the speaker or the at least one communication circuit.

According to an embodiment, the message may further include a text. According to an embodiment, the instructions may cause the processor to parse the message in order to recognize the text.

According to an embodiment, the instructions may cause the processor to receive another message that includes a text using the communication circuit, and to parse the other message in order to recognize the text.

According to an embodiment, the link may include a web page related link.

According to an embodiment, the one or more items of the link or the content may include a video file, an image file, or an audio file.

According to an embodiment, the instructions, when executed, may cause the processor to extract, if the item includes a video file or an audio file, at least a part of speech information that is included in the video file or the audio file, and to provide the extracted speech to the speaker or the at least one communication circuit.

According to an embodiment, the external resource may include content which corresponds to the link and is stored in an external server.

According to an embodiment, the instructions, when executed, may cause the processor to generate the text on the basis of domain information that is included in the link, to convert the generated text into a speech, and to provide the converted speech to the speaker or the at least one communication circuit.

According to an embodiment, the instructions, when executed, may cause the processor to generate the text on the basis of information that is included in a Hypertext Markup Language (HTML) source file for the web page, to convert the generated text into a speech, and to provide the converted speech to the speaker or the at least one communication circuit.

An electronic device according to various embodiments of the present disclosure may include at least one communication circuit; a display; a speaker; a processor electrically connected to the communication circuit, the display, and the speaker; and a memory electrically connected to the processor. The memory, when operated, may store instructions to cause the processor to receive a message that includes at least one item of a link or content and a text through the communication circuit, to parse the message in order to recognize the text and the at least one item, to extract or receive content from the at least one item or from an external resource related to the at least one item, to convert the message into at least one of a speech, a sound, an image, a video, and data on the basis of at least one of the parsed message and the extracted or received content, and to provide the at least one of the speech, the sound, the image, the video, and the data to the speaker or the at least one communication circuit.

An electronic device according to various embodiments of the present disclosure may include at least one communication circuit; a display; a speaker; a memory; and a processor electrically connected to the communication circuit, the display, the speaker, and the memory. The memory, when operated, may store instructions to cause the processor to receive a message that includes a text and at least one link or content through the communication circuit, to identify sound related information from the message, to generate sound data related to the text or the at least one link or content on the basis of the sound related information, and to provide the sound data to the speaker.

According to an embodiment, the sound related information may be acquired through a web page that corresponds to the link.

According to an embodiment, the sound related information may be acquired through domain information that is included in the link.

According to an embodiment, the sound related information may be information that is included in an HTML, source file of a web page that corresponds to the link.

According to an embodiment, the instructions may cause the processor to convert the message into a second message on the basis of history information of the received message and to provide the second message to the speaker.

An electronic device according to various embodiments of the present disclosure may include at least one communication circuit; a display; a speaker; a memory; and a processor electrically connected to the communication circuit, the display, the speaker, and the memory. The memory, when operated, may store instructions to cause the processor to receive a message that includes a text and at least one link or content through the communication circuit, to convert the link into a text if the link is included in the message, to convert the message that includes the text into a speech, and to provide the converted speech to the speaker.

According to an embodiment, the instructions may cause the processor to generate, if an advertisement is included in the received message, a text that includes information related to the advertisement, to convert the text into a speech, and to provide the converted speech to the speaker.

In the description, the term “regeneration of the notification (e.g., message)” may include conversion, replacement, deletion, and addition of at least a part of the notification; conversion of the notification; and generation of a new notification in all.

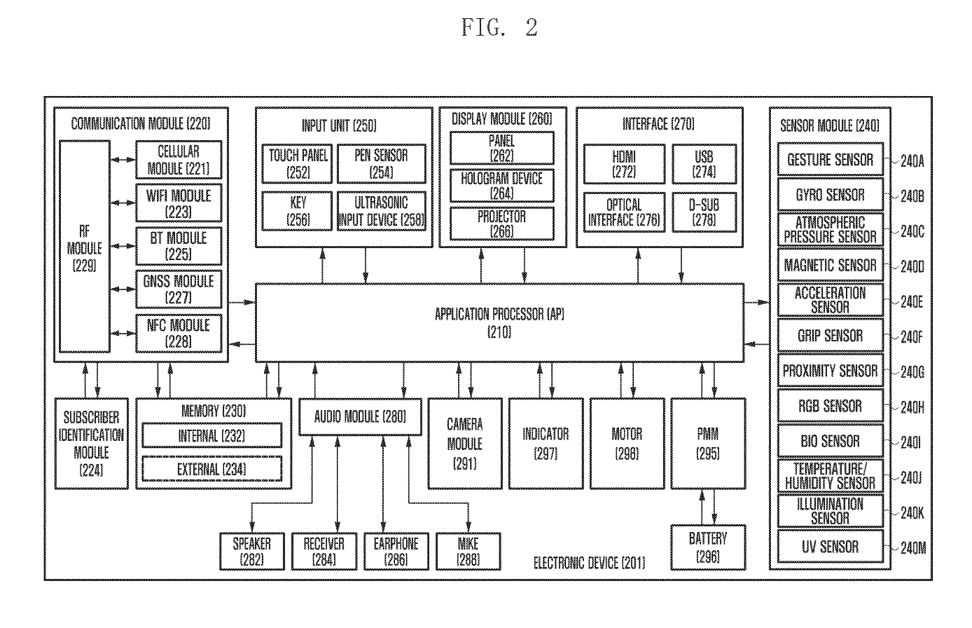

FIG. 2 is a block diagram illustrating an electronic device 201 according to an embodiment of the present disclosure. The electronic device 201 may form, for example, the whole or part of the electronic device 201 shown in FIG. 1.

Referring to FIG. 2, the electronic device 201 may include at least one application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 170) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 323, a BT module 225, a GPS module 227, an NFC module 228, and a radio frequency (RF) module 229.

The cellular module 221 may offer a voice call, a video call, a message service, an internet service, or the like through a communication network (e.g., long term evolution (LTE), LTE advanced (LTE-A), code division multiple access (CDMA), wideband CDMA (WCDMA), universal mobile telecommunications system (UMTS), wireless broadband (WiBro), or global system for mobile (GSM), etc.). Additionally, the cellular module 221 may perform identification and authentication of the electronic device in the communication network, using the SIM card 224. According to an embodiment, the cellular module 221 may perform at least part of functions the AP 210 can provide. For example, the cellular module 221 may perform at least part of a multimedia control function.

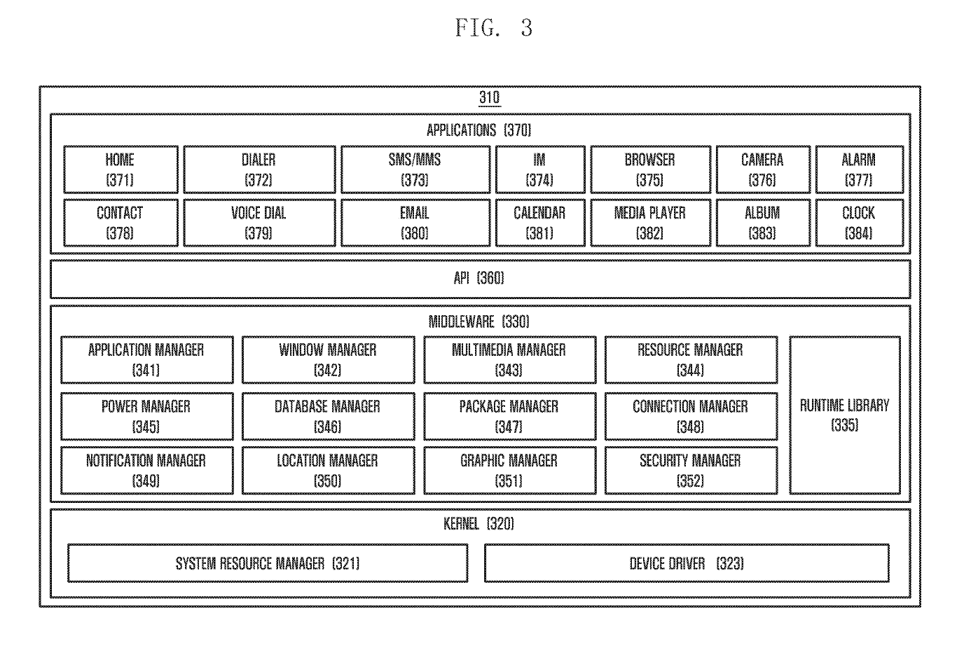

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 3, the AP 210 may be formed to have at least part (e.g., the cellular module 321) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single integrated circuit (IC) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a power amp module (PAM), a frequency filter, a low noise amplifier (LNA), or the like. Also, the RF module 229 may include any component, e.g., a wire or a conductor, for transmission of electromagnetic waves in a free air space. Although FIG. 3 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224 may be a specific card formed of SIM and may be inserted into a slot formed at a certain place of the electronic device 201. The SIM card 224 may contain therein an integrated circuit card identifier (ICCID) or an international mobile subscriber identity (IMSI).

The memory 230 (e.g., the memory 130) may include an internal memory 232 and an external memory 234. The internal memory 232 may include, for example, at least one of a volatile memory (e.g., dynamic RAM (DRAM), static RAM (SRAM), synchronous DRAM (SDRAM), etc.) or a nonvolatile memory (e.g., one time programmable ROM (OTPROM), programmable ROM (PROM), erasable and programmable ROM EPROM), Electrically EPROM (EEPROM), mask ROM, flash ROM, NAND flash memory, NOR flash memory, etc.). According to an embodiment, the internal memory 232 may have the form of a solid state drive (SSD). The external memory 234 may include a flash drive, e.g., compact flash (CF), secure digital (SD), micro secure digital (Micro-SD), Mini-SD, eXtreme digital (xD), memory stick, or the like. The external memory 334 may be functionally connected to the electronic device 201 through various interfaces. According to an embodiment, the electronic device 301 may further include a storage device or medium such as a hard drive.

The sensor module 240 may measure physical quantity or sense an operating status of the electronic device 201, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 240 may include a control circuit for controlling one or more sensors equipped therein.

The input device 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 201 through an input tool that generates ultrasonic signals, thus allowing wireless recognition. According to an embodiment, the electronic device 201 may receive a user input from any external device (e.g., a computer or a server) connected thereto through the communication module 220.

The display 260 (e.g., the display 250) may include a panel 262, a hologram 264, or a projector 266. The panel 262 may be, for example, liquid crystal display), active matrix organic light emitting diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. According to an embodiment, the display 260 may further include a control circuit for controlling the panel 262, the hologram 264, and the projector 266.

The interface 270 may include, for example, a high-definition multimedia interface (HDMI) 272, a universal serial bus (USB) 274, an optical interface 276, or a D-subminiature (D-sub) 278. The interface 270 may be contained, for example, in the communication interface 160 shown in FIG. 1. Additionally or alternatively, the interface 270 may include, for example, a mobile high-definition link (MHL) interface, an SD card/multi-media card (MMC) interface, or an infrared data association (IrDA) interface.

The audio module 280 may perform a conversion between sounds and electric signals. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an ISP image signal processor, not shown), or a flash (e.g., LED or xenon lamp, not shown).

The power management module 295 may manage electric power of the electronic device 201. Although not shown, the power management module 295 may include, for example, a power management integrated circuit (PMIC), a charger IC, or a battery or fuel gauge.

The PMIC may be formed, for example, of an IC chip or system on chip (SoC). Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 301 may include a specific processor (e.g., graphic processing unit (GPU)) for supporting a mobile TV. This processor may process media data that comply with standards of digital multimedia broadcasting (DMB), digital video broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of application-specific integrated circuit (ASIC) chip, field-programmable gate arrays (FPGAs), and programmable-logic device, which have been known or are to be developed.

FIG. 3 is a block diagram illustrating a configuration of a programming module 310 according to an embodiment of the present disclosure.

The programming module 310 may be included (or stored) in the electronic device 301 (e.g., the memory 330) illustrated in FIG. 1 or may be included (or stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware, and may include an operating system (OS) controlling resources related to an electronic device (e.g., the electronic device 101 or 201) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 211) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 435 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 101) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 460 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 (e.g., the applications 147) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the application processor 210), the one or more processors may perform functions corresponding to the instructions. The non-transitory computer-readable storage medium may be, for example, the memory 220. At least a part of the programming module 310 may be implemented (e.g., executed) by, for example, the one or more processors. At least a part of the programming module 310 may include, for example, a module, a program, a routine, a set of instructions, and/or a process for performing one or more functions.

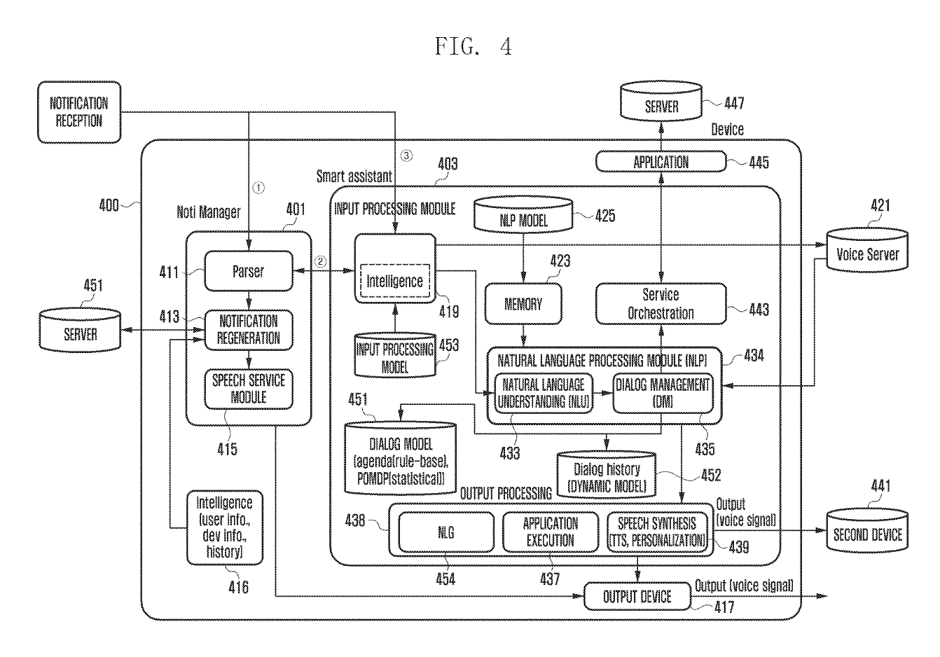

FIG. 4 is a block diagram of an electronic device according to various embodiments of the present disclosure. More specifically, FIG. 4 is a diagram of an electronic device that includes a smart assistant module 403 and/or a server.

According to various embodiments, at least parts of constituent elements of the smart assistant module 403 may include an external server or another electronic device that is functionally connected to the electronic device.

According to an embodiment, the electronic device 400 may perform an operation on the basis of at least a part of at least one of notifications that are received from an outside or generated inside the electronic device 400. For example, if a notification is received, the electronic device 400 may operate to output the received notification through a speech. According to an embodiment, if additional information is required in order to output the notification through the speech, the electronic device 400 may operate to regenerate the notification.

According to an embodiment, the electronic device 400 may include a notification (Noti) manager 401 and/or the smart assistant module 403. According to an embodiment, the above-described operation and/or an operation related to the above-described operation performance may be performed through the notification manager 401 that is included in the electronic device, the smart assistant module 403, a server that is functionally connected to the electronic device, and/or at least one external device.

According to various embodiments, in the case where a notification is received, the electronic device 400 may determine whether the current mode is a speech service mode, and if the current mode is not the speech service mode, the electronic device 400 may transmit the notification to the notification manager 401. The notification may include a message.

If the current mode is the speech service mode, the electronic device 400 may transfer the notification to the smart assistant module 403. The electronic device 400 may determine whether the current mode is the speech service mode on the basis of the state of the electronic device 400. For example, in the case where the electronic device 400 is in an eyes-free state, the electronic device 400 may determine that the current mode is the speech service mode. The eyes-free state may be a state where a user does not watch the electronic device 400, and if the user is exercising or is driving a car, the electronic device 400 may determine that the electronic device 400 is in the eyes-free state. As another example, if the electronic device 400 operates in an access mode in accordance with user's setting, the electronic device 400 may determine that the current mode is the speech service mode. As still another example, if the electronic device 400 is connected to a peripheral device (e.g., wearable device or external speaker), the electronic device 400 may determine that the current mode is the speech service mode.

According to an embodiment, the electronic device may operate to parse the notification through the notification manager 401, to regenerate the notification, and to convert the notification into a speech to output the converted speech.

For example, a parser module 411 may parse the received notification. The parser module 411 may determine whether information related to sound (e.g., voice) is included in the notification through parsing of the notification. A notification regeneration module 413 may regenerate the notification if the information related to the sound is included in the notification. For example, the notification regeneration module 413 may acquire additional information on the basis of at least a part of the information of the notification, and may regenerate the notification using a part of the acquired additional information. For example, the notification regeneration module 413 may acquire the additional information from a link (e.g., URL) that is included in the notification, a web page that is connected to the link, or content (e.g., image or moving image). The notification regeneration module 413 may regenerate the notification through changing of at least a part of the received notification using the additional information. A speech service module 415 may convert the received notification or the regenerated notification into a speech. The speech service module 415 may operate to output the converted speech through an output device (e.g., speaker) 417.

According to an embodiment, the notification manager 401 may include at least one of the parser module 411, the notification regeneration module 413, and/or the speech service module 415.

According to an embodiment, if at least one notification is received from the outside or inside of the electronic device, the parser module 411 may perform parsing of the received notification, and may determine whether information related to sound (e.g., voice) is included in the notification. If the notification includes the information related to the sound as the result of the determination, the parser module 411 may transfer at least a part of the related information to the notification regeneration module 413 or the smart assistant module 403. For example, the parsing operation may be an operation for determining whether the received notification includes the information related to the speech information on the basis of at least a part of the information of the notification. According to an embodiment, the sound related information may be the URL or content (e.g., moving image or music) that is included in the notification. As another example, the parser module may not perform the parsing of the received notification, but may directly transfer the notification to the smart assistant module 403. For example, if the notification does not include the sound related information as the result of the determination, the parser module 411 may directly transfer at least a part of the related information to the notification regeneration module 413 or the speech service module 415.

According to an embodiment, if the notification includes at least a part of the information related to the speech information, the notification regeneration module 413 may regenerate the notification on the basis of at least a part of information related to the notification. According to an embodiment, the notification regeneration module 413 may request or receive information that is necessary for the regeneration from an external server 451 using at least a part of the information that is included in the notification in order to regenerate the message. As still another example, the electronic device may acquire the information that is necessary for the regeneration of the notification from an intelligence module 416. For example, the electronic device 400 may acquire at least a part of user related information and device related information from the intelligence module 416. According to an embodiment, the regenerated notification may be transferred to the speech service module 415. As still another example, if the regeneration of the notification is not necessary, the related information may be transferred to the speech service module without the notification regeneration operation.

According to an embodiment, the speech service module 415 may output the notification as a speech on the basis of at least a part of the notification. For example, the notification that is output as the speech may be a notification that is transferred from the parser module 411 or the notification regeneration module 413. According to various embodiments, the speech service module may operate together with various other modules that are included in the electronic device 400, such as a display. For example, in the case where the speech service module outputs the notification as a speech, the display may display the notification. For example, the electronic device 400 may output a tactile feedback (e.g., vibration) while outputting the speech through the speech service module. According to various embodiments, the electronic device 400 may perform various operations in addition to the above-described operations while providing the speech service.

According to an embodiment, the smart assistant module 403 may include an input device (not illustrated), an input processing module 419, a natural language processing module 434, an output processing module 438, a service orchestration module 443, a dialog history model 452, an input processing model 453, a natural language processing model 425, a dialog model 451, and a memory 423. As still another example, at least a part of the smart assistant function may be included in servers 421, 447, and 451 that are functionally connected to the electronic device or another electronic device. According to an embodiment, the smart assistant module 403 may analyze the notification that is received from the notification manager 401 or the outside, reconfigure the notification, and convert the reconfigured notification into a speech to output the converted speech.

For example, the smart assistant module 403 may include the input processing module 419, the natural language processing module 434, the output processing module 438, the service orchestration module 443, the dialog history model 452, the input processing model 453, the natural language processing model 425, the dialog model 451, and the memory 423. For example, the natural language processing module 434 may include a natural language understanding (NLU) module 433 and a dialog manager (DM) module 435.

According to an embodiment, the input processing module 419 may include an intelligence processing module. The input processing module 419 may process a text and a speech input to provide an NLU input. For example, the input processing module 419 may process a user text input that is received from the input device or a graphic user interface (GUI) object input. For example, if a user input is detected through various input devices that are provided on the electronic device 400, the input processing module 419 may determine whether a speech recognition activation condition has occurred. The speech recognition activation condition may be differently set for each operation of the input device that is provided on the electronic device. According to a certain embodiment, the input processing module 419 may receive a trigger input from an external device (e.g., wearable device connected through short-range wireless communication).

According to an embodiment, the NLP module 434 may include the NLU module 433 and/or the DM module 435. The natural language processing module 434 may refer to natural language processing model data 425. For example, the natural language processing module 434 may be implemented in a hybrid type in which a client (e.g., electronic device 400) and servers 421, 447, and 451 simultaneously perform natural language processing.

The natural language processing module 434 may perform syntactic analyzing. The natural language processing module 434 may parse input data and may output the data in a grammatical unit (word or phrase). The natural language processing module 434 may perform semantic analyzing of the parsed data, and may divide the data into domains, intents, and slots. The natural language processing module 434 may give marks with respect to the data that is divided into domains, intents, and slots, and may select the data having the highest mark to derive the user intention for the input data.

According to an embodiment, the natural language understanding module 433 may be implemented in the servers 421, 447, and 451 and/or the client (e.g., electronic device 400). Language data that is input to the client (e.g., electronic device 400) and/or the servers 421, 447, and 451 may be processed by respective natural language understanding modules 433 of the servers 421, 447, or 451 and/or the client (e.g., electronic device 400).

According to an embodiment, the dialog manager module 435 may perform a dialog management function. The dialog manager module 435 may determine the next action of the smart assistant system 403 on the basis of the intent and/or slot that is grasped through the natural language understanding module 433. For example, the dialog manager module 435 may determine and perform the next action on the basis of an agenda that is defined in the smart assistant module 433. That is, the dialog manager module 435 may manage a flow of dialog, manage the slot, determine whether the slot is sufficient, and request necessary information. As still another example, the dialog manager module 435 may also manage dialog status. As still another example, the dialog manager module 435 may manage a task flow, and the smart assistant module 433 may determine what operation can be performed through calling of an application or a service. The dialog manager module 435 may refer to a database of a dialog model 451 and/or dialog history database 452.

According to an embodiment, the intelligence module 416 may collect data through a use history of a user's electronic appliance (e.g., electronic device 400), and may grasp the user intention. For example, the use history may include a recent dialog history, user's recent selection history (e.g., originating call number, map selection history, or media reproduction history), a history in dialog, a web browser cookie, a user request history, a result sequence for a recent user request, a history of UI events (e.g., button input, tap, gesture, and speech activation trigger), and user terminal's sensor data information (e.g., location, time, motion, illumination, sound level, and positional orientation). For example, data that is acquired by the intelligence module 416 may include user data (e.g., user preferences, identities, authentication credentials, accounts, and addresses), user collection data (e.g., bookmarks, favorites, and clippings), stored lists (e.g., stored lists for various subjects, such as businesses, hotels, stores, and theaters, URLs, titles, phone numbers, locations, maps, and photos), stored data (e.g., various kinds of content, such as movies, videos, and music), calendars, schedule information, to do list(s), reminders and alerts, contact databases, social network lists, shopping lists and wish lists (e.g., information on goods, services, coupons, and discount codes), history information, and receipts.

According to an embodiment, the service orchestration module 443 may call and execute a service that corresponds to a task that suits the grasped user intention. The service orchestration module 443 may execute a related application through an application execution unit 445. The application execution unit 445 may call and execute the related service with reference to a server 447.

Various services may correspond to tasks. A service that corresponds to a task may be an application that is installed in the electronic device 400 or a service that is provided by a third party. For example, a service that may be used to set an alarm may be an alarm application or calendar application in the electronic device 400, and the service orchestration module 443 may select and execute the application that suits the user intention among the above-described applications. According to an embodiment, the electronic device 400 may search for a service that suits a user intention using an API that is provided by a third party and may provide the searched service. For example, in the case where the electronic device 400 provides a speech service, the service orchestration module 443 may execute an application related to the speech service or an application that corresponds to a function to be provided together with the speech service.

According to an embodiment, the output processing module 438 may include a Natural Language Generation (NLG) module 454, an application execution module 437, and/or a speech synthesis module 439. For example, the output processing module 438 may construct and render data to be output to the output device 417 and/or the second electronic device 441. The output processing module 438 may output the data to be output in various forms, such as text, graphics, and speech.

According to an embodiment, the NLG module 454 may generate a natural language. For example, the NLF module 454 may generate and output a paraphrased natural language with respect to the user input.

According to an embodiment, the application execution module 437 may execute a corresponding application in order to perform a task that suits the user intention. For example, the application execution module 437 may execute a related application in the case where the electronic device 400 provides a speech service.

According to an embodiment, the speech synthesis module 439 may construct a response that suits the user intention to synthesize the response into a speech. For example, the speech synthesis module 439 may convert the data (e.g., notification) into a speech on the basis of the result of the processing that is performed by the natural language processing module 434, or may synthesize the speech.

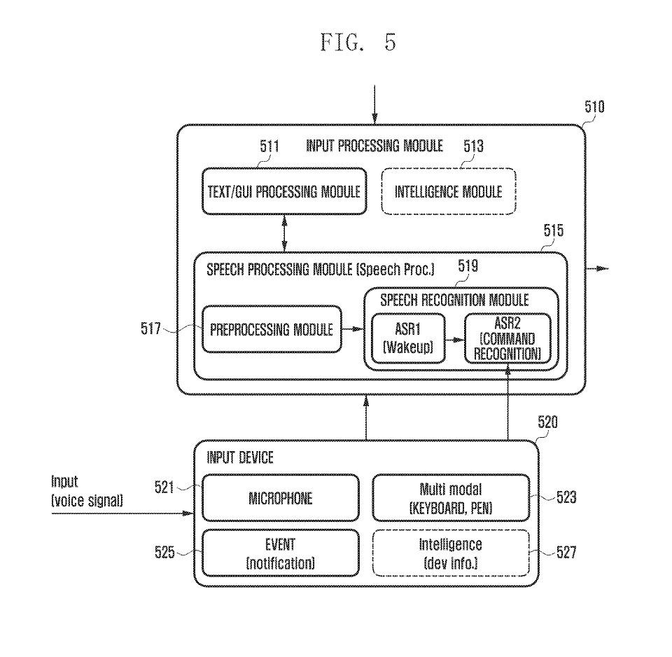

FIG. 5 is a diagram explaining the operations of an input processing module and an input device of an electronic device according to an embodiment of the present disclosure.

According to various embodiments, an electronic device may include an input processing module 510 and/or an input device 520. According to an embodiment, the input device 520 may include a microphone 521, a multimodal (e.g., input through all of a keyboard and a speech) 523, an event (notification) module 525, and an intelligence module 527. The input device 520 may include a known input means in addition to those as described above. For example, the input device 520 may receive an input (e.g., speech signal), and may transfer the received input to the input processing module 510.

According to an embodiment, the input device 520 may receive at least one input from an electronic device, a server that is functionally connected to the electronic device, or another electronic device. For example, the electronic device may receive an input from a user through at least one of a microphone, a touch screen, a pen, a keypad, and a hardware key, which are included in the electronic device. For example, the electronic device may receive a user input through a graphic user interface (GUI) (e.g., menu or keypad) that is displayed on a screen of the electronic device or an input device (e.g., keyboard or mouse) that is functionally connected to the electronic device, and may receive a user speech input through at least one microphone that is included in the electronic device. As another example, the input device 520 may receive at least one input signal from a speech input system. As still another example, a notification (e.g., system notification) that is generated from the electronic device may be one input, and a notification (e.g., message mail arrival notification, scheduling event occurrence notification, or third party push notification) that is generated from a server that is functionally connected to the electronic device or another device may be input to the input device. The electronic device may receive notification related information that is transferred from a notification manager. As still another example, the electronic device may receive the input through a multimodal. For example, the electronic device may simultaneously receive a user text input and a user speech input.

According to an embodiment, the input processing module 510 may include an intelligence module 513, a text/GUI processing module 511, and a speech processing module 515. The input processing module 510 may process a text input and a speech input, and may provide an NLU input. For example, the text/GUI processing module 511 may process the user text input that is received from the input device or a graphic user interface object input. For example, the speech processing module 515 may include a preprocessing module 517 and a speech recognition module 519. As still another example, if a user input is detected through various input devices that are provided on the electronic device, the input processing module 510 may determine whether a speech recognition activation condition has occurred. The speech recognition activation condition may be differently set for each operation of an input device 520 that is provided on the electronic device. For example, if a short or long press input of a physical hard key, such as a button type key (e.g., power key, volume key, or home key), provided on the electronic device or a soft key, such as a touch key (e.g., menu key or cancellation key), is detected, or a specific motion input (or gesture input) is detected through a pressure sensor or a motion sensor, the speech recognition module 519 may determine that the speech recognition activation condition based on the user input has occurred. For example, the speech recognition module 519 may determine that a wakeup condition that is performed by a first automatic speech recognition (ASR) module has occurred. According to a certain embodiment, the input processing module 510 may receive a trigger input from an external device (e.g., wearable device connected through short-range wireless communication).

According to an embodiment, if the speech recognition activation condition occurs with respect to the user input, the speech recognition module 519 may confirm an activation request from a speech command recognition module and trigger information according to the user input type, and may transfer the confirmed information to a speech recognition module (second ASR module). Here, the trigger information may be information that indicates the kind of an input hard key or soft key, an input time of the hard key or soft key, gesture direction, current location information of an electronic device, and whether an external device is connected thereto. Further, the trigger information may be information that indicates a specific function domain (e.g., message domain, call domain, contact address domain, music reproduction domain, or camera domain) that is determined in accordance with the user input type. According to an embodiment, the speech recognition module 519 may perform recognition of a trigger speech for triggering the speech recognition module 519. For example, the trigger speech may be a designated word (e.g., isolating word such as “Hi Galaxy” or keyword). For example, the trigger recognition may be performed through the first ASR module, and a speech signal that is additionally input after the trigger speech is recognized may be transferred to the speech recognition module. The input processing module 510 may process the speech signal using an input processing module.

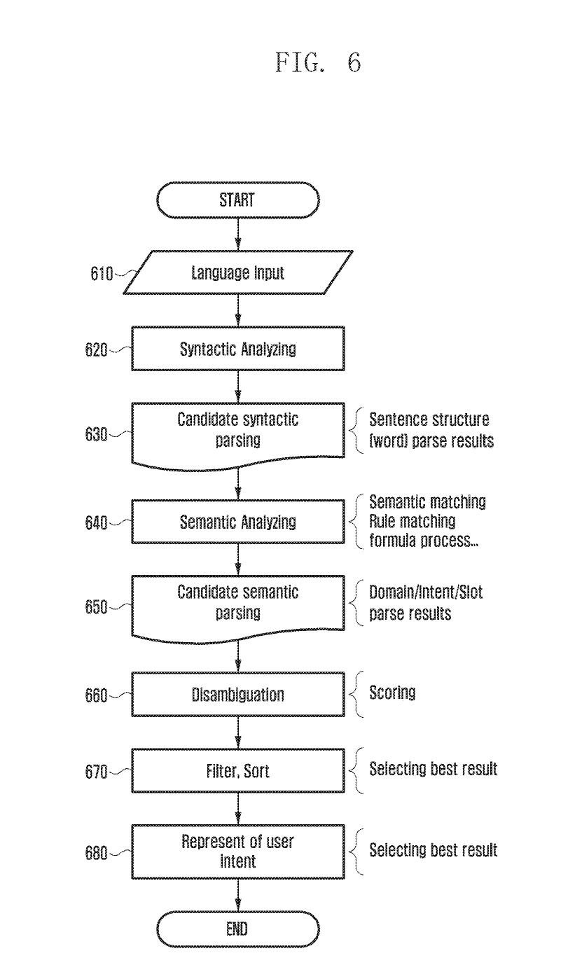

FIG. 6 is a flowchart explaining the operation of a natural language processing module according to an embodiment of the present disclosure.

According to an embodiment, at operation 610, the natural language processing module may receive an input of a language. For example, the natural language processing module may receive an input of data (e.g., language) from the input processing module. For example, the natural language processing module may receive an input of a language which is included in a notification that is received by the electronic device.

According to an embodiment, at operation 620, the natural language processing module may perform syntactic analyzing. For example, the natural language processing module may analyze the input data (e.g., language) in a set grammatical unit.

According to an embodiment, at operation 630, the natural language processing module may perform candidate syntactic parsing. For example, the natural language processing module may parse the input data to output the parsed data in the unit of a sentence structure or a word.

According to an embodiment, at operation 640, the natural language processing module may perform semantic analyzing of the parsed data. For example, the natural language processing module may analyze the parsed data according to a set rule or formula.

According to an embodiment, at operation 650, the natural language processing module may perform candidate semantic parsing. For example, the natural language processing module may divide the parsed data into domains, intents, and slots.

According to an embodiment, at operation 660, the natural language processing module may perform a disambiguation operation. For example, the natural language processing module may give marks with respect to the data that is divided into domains, intents, and slots.

According to an embodiment, at operation 670, the natural language processing module may filter or sort the data. For example, the natural language processing module may select specific data on the basis of the marks given at operation 660.

According to an embodiment, at operation 680, the natural language processing module may derive user intent. For example, the natural language processing module may output the selected data through derivation of the user intention.

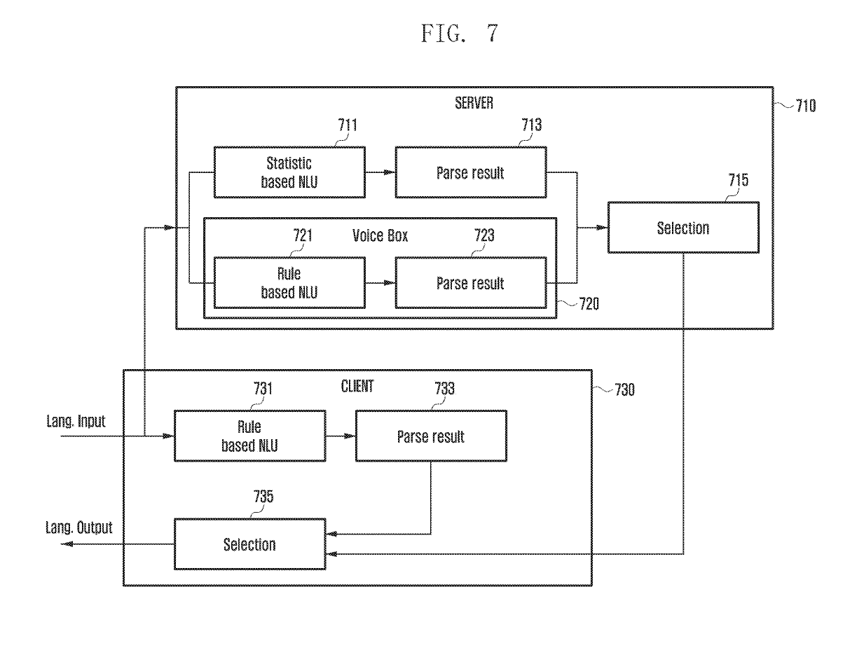

FIG. 7 is a block diagram of a natural language understanding module according to an embodiment of the present disclosure.

Referring to FIG. 7, the natural language understanding module may include a server 710 and/or a client 730. According to an embodiment, the natural language understanding module may receive an input of data (e.g., language). For example, the input data may be input to the server 710 or the client 730.

According to an embodiment, the server 710 may include a statistic based NLU module 711, a rule based NLU module 721, one or more parsing modules 713 and 723, and a selection module 715. The rule based NLU module 721 and the parsing module 723 may constitute a voice box 720.

According to an embodiment, the statistic based NLU module 711 and/or the rule based NLU module 723 of the server may receive an input of a language. The statistic based NLU module 711 may extract a linguistic feature of the input data. The statistic based NLU module 711 may analyze the user intention through analyzing of distribution probability of the extracted linguistic feature. The rule based NLU module 721 may analyze the user intention on the basis of a set rule. For example, the rule based NLU module 721 may determine an operation that corresponds to the language that is included in the input data on the basis of the set rule.

The parsing modules 713 and 723 may parse the data that is processed by the statistic based NLU module 711 or the rule based NLU module 721. The selection module 715 may select at least one piece of data output from the parsing modules 713 and 723 to transfer the selected data to a selection module 735 of the client.

According to an embodiment, the client 730 may include a rule based NLU module 731, a parsing module 733, and a selection module 735. For example, the rule based NLU module 731 may analyze the user intention on the basis of the set rule. The parsing module 733 may parse the data that is processed by the rule based NLU module to transfer the parsed data to the selection module 735. The selection module 715 may select at least one piece of data output from the parsing modules 713 and 723 and may transfer the selected data to the selection module 735 of the client. The selection module 735 may select and output at least one piece of the input data. For example, the selection module 735 may output the selected language.

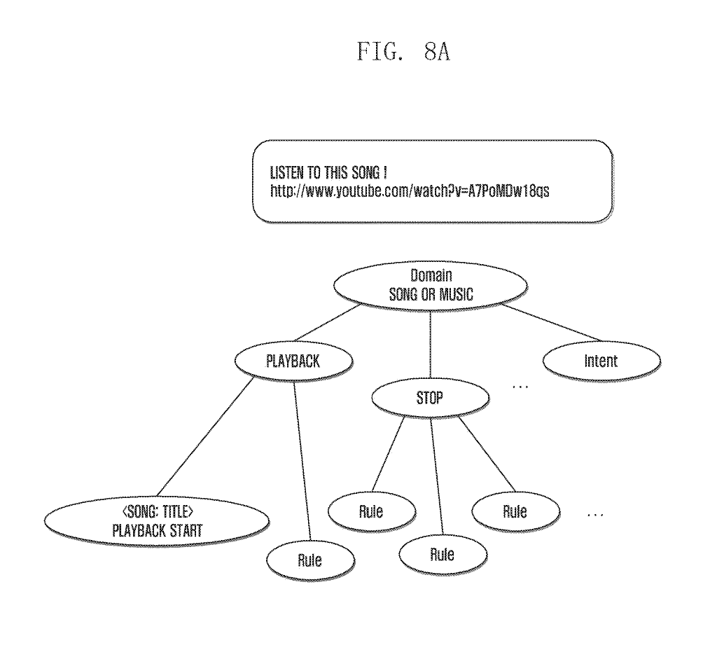

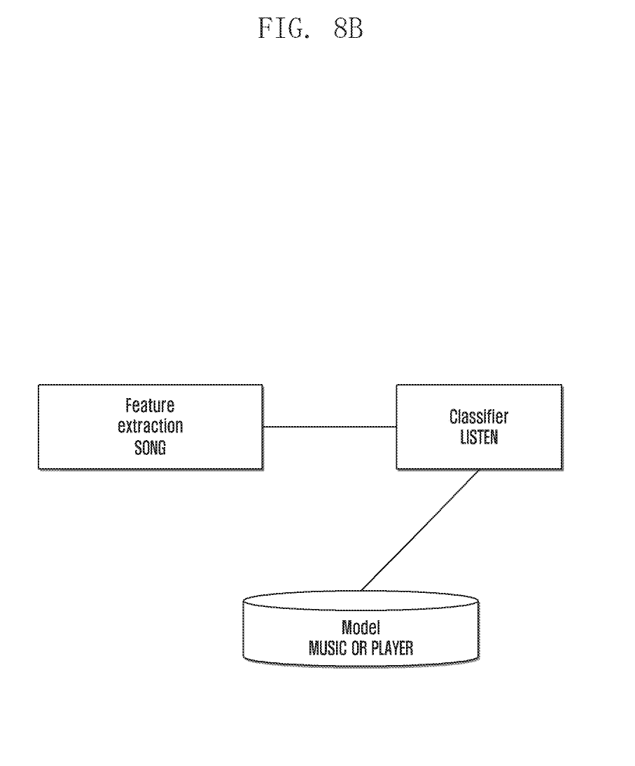

FIGS. 8A and 8B are diagrams explaining the operation of a natural language understanding module according to various embodiments of the present disclosure. FIG. 8A illustrates an example in which the natural language understanding module performs rule based analyzing, and FIG. 8B illustrates an example in which the natural language understanding module perform statistic based analyzing.

Referring to FIG. 8A, the natural language understanding module may analyze the input data (e.g., language) on the basis of the rule. For example, the natural language understanding module may search for the rule that corresponds to the intention of the language through analyzing of the input language in the order of the domain, intent, and rule.

For example, the natural language understanding module may extract a specific word that is included in the notification, determine the domain that corresponds to the extracted word, and determine corresponding intent and rule. For example, if a word “song” is included in the notification, the natural language understanding module may determine a song or music domain, determine a reproduction intent, and determine a rule, such as song reproduction start.

Referring to FIG. 8B, the natural language understanding module may analyze the input data (e.g., language) on the basis of the statistics. For example, the natural language understanding module may extract a linguistic feature of the input language. The natural language understanding module may determine a related intent on the basis of the extracted linguistic feature. For example, the natural language understanding module may extract the linguistic feature “song” of an input word, and may search for a language having the meaning of “listen to” according to statistically distributed data of the extracted feature. The natural language understanding module may determine a related model (e.g., music or music player) on the basis of the language “listen to”.

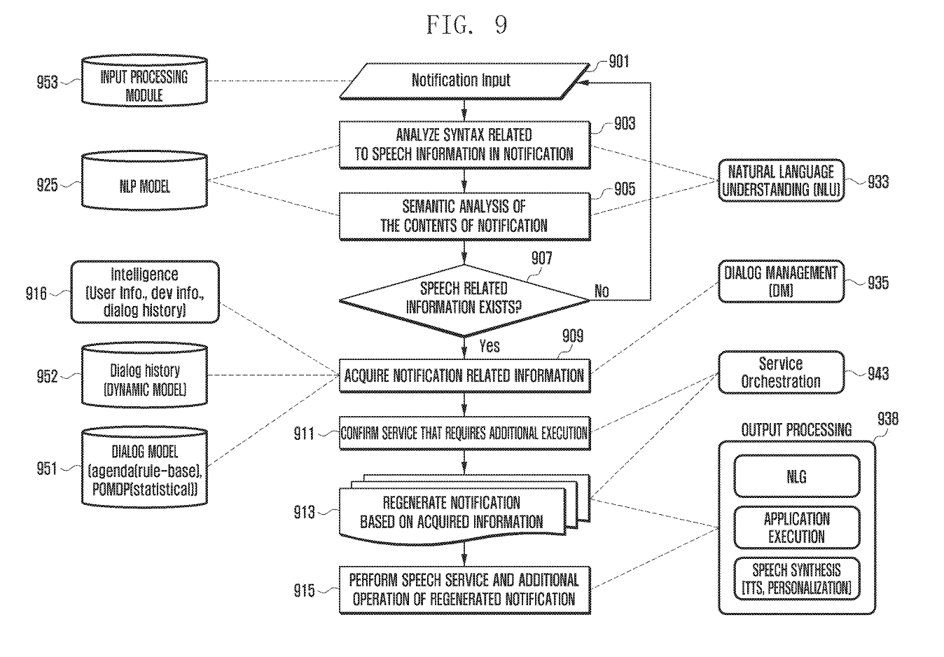

FIG. 9 is a diagram illustrating a process of processing a notification in an electronic device according to an embodiment of the present disclosure.

Referring to FIG. 9, at operation 901, the electronic device may receive an input of a notification. For example, the electronic device may transmit a notification that is generated in the electronic device or a notification that is received from an external device (or external server) to a smart assistant module. Further, the electronic device may transfer a notification that is generated in the electronic device or a notification that is received from an external device (or external server) to a notification manager, and may transfer the notification to the smart assistant module through the notification manager.

According to an embodiment, if the notification is input, the electronic device may divide and process a text and an attached file that are included in the notification. In this case, the electronic device 201 may process the notification with reference to an input processing model database 953.

According to an embodiment, at operation 903, the electronic device may analyze if there is a syntax that is related to speech information in the notification. The electronic device may perform natural language processing of the notification with reference to a natural language processing model database 925, and may determine if there is a syntax that is related to the speech information.

According to an embodiment, at operation 905, the electronic device may perform semantic analyzing of the contents of the notification. The electronic device may refer to the natural language processing model database 925 while performing the semantic analyzing.

According to an embodiment, the electronic device may perform operation 903 and/or operation 905 through a natural language understanding module 933.

According to an embodiment, at operation 907, the electronic device may determine if there is speech related information in the notification. For example, the electronic device may determine if there is the speech related information in the notification on the basis of at least a part of the result of the syntactic/semantic analyzing.

According to various embodiments, if there is the speech related information as the result of the determination at operation 907, the electronic device, at operation 909, may acquire notification related information. For example, in order to acquire the speech related information, the electronic device may process the data through a dialog management module 935, and may refer to an intelligence module 916, a dialog history database 952, and dialog model database 951.

According to an embodiment, at operation 911, the electronic device may confirm a service that requires an additional execution.

According to an embodiment, at operation 913, the electronic device may regenerate the notification on the basis of the acquired information (e.g., information on the service that requires the additional execution).

According to an embodiment, at operation 915, the electronic device may provide the regenerated notification through a speech service, or may perform a related additional operation.

According to an embodiment, the electronic device may perform operation 911 and/or operation 913 through a service orchestration module 943. According to an embodiment, the electronic device may perform operation 913 and operation 915 through an output processing module 938.

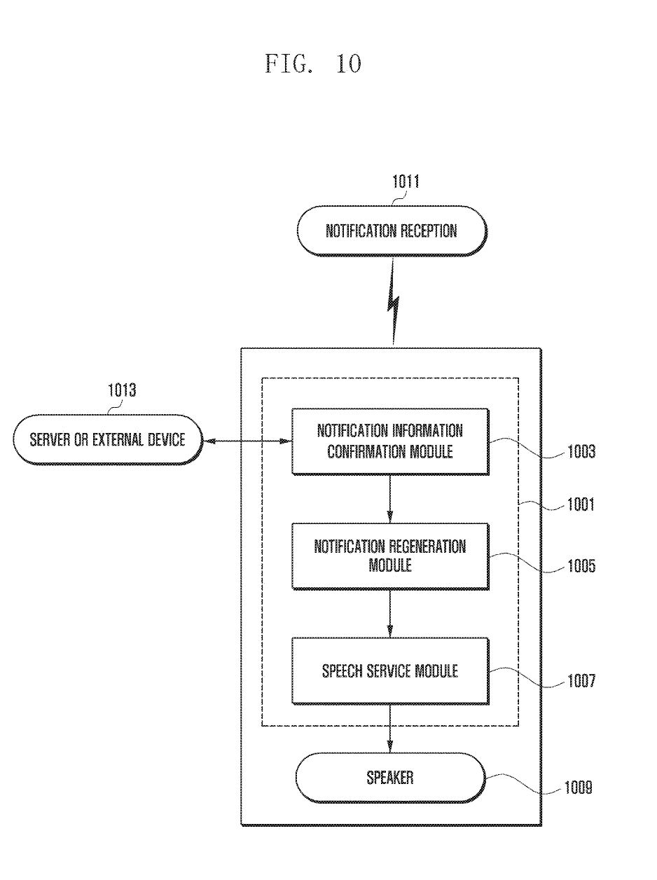

FIG. 10 is a diagram illustrating a notification management module of an electronic device according to an embodiment of the present disclosure. According to various embodiments, the electronic device may include a notification management module 1001 and a speaker 1009. For example, the notification management module 1001 may be a software module, and may be stored in a memory as an instruction code. For example, the instruction code may be loaded to a processor when the electronic device is operated to perform a corresponding function. Further, the notification management module 1001 may be provided in a separate hardwired type.

Referring to FIG. 10, the notification management module 1001 may include a message information confirmation module 1003, a message regeneration module 1005, and/or a speech service module 1007.

According to an embodiment, if the notification (e.g., message) is received (1011), the notification information confirmation module 1003 may analyze the received notification. For example, the notification information confirmation module 1003 may confirm whether speech related information (e.g., moving image, URL information, and speech file) is included in the notification.

For example, if the reception of the notification (e.g., message) is sensed, the notification information confirmation module 1003 may determine whether the speech related information is included in the notification through analyzing of the received notification. For example, if a music file is included in the message, the notification information confirmation module 1003 may determine that the message includes the speech related information. As another example, if a moving image URL is included in the message, the notification information confirmation module 1003 may determine whether the speech related information is included through domain information of the URL or an HTML source file that is acquired through the URL.

According to various embodiments, if the speech related information is included in the received notification, the notification information confirmation module 1003 may transfer information related to notification regeneration to a notification regeneration module. For example, the notification information confirmation module 1003 may determine existence/nonexistence of the speech related information on the basis of at least one of notification text, link, and content. For example, the notification may include at least one item and/or text of the link or content. For example, the notification (e.g., message) may include at least one of a text, a link (e.g., URL address) connected to a specific web site, and content of a photo or a moving image. For example, if the notification includes a music file, a moving image file, a sound file, or an URL (e.g., URL related to sound or moving image content), the notification information confirmation module 1003 may determine that the speech related information is included in the notification.

For example, if a music file is attached to the message, the notification information confirmation module 1003 may determine that the speech related information is included in the message. According to an embodiment, the notification information confirmation module 1003 may extract a header through analyzing of the file that is attached to the notification, and may determine whether the attached file is a music file through analyzing of the header. According to an embodiment, the notification information confirmation module 1003 may determine whether the attached file is a music file on the basis of an extension of the file that is attached to the message. For example, if the extension of the attached file is mp3, mp4, ogg, or fac, the notification information confirmation module 1003 may determine that the attached file is a music file. As still another example, if the message includes URL information (e.g., moving image URL), the notification information confirmation module 1003 may determine whether the speech related information is included in the message through analyzing of URL domain information or an HTML, source. Further, the notification information confirmation module 1003 may analyze the dialog contents included in the contents (e.g., “Listen to this”) of the message using ontology, and may determine that the speech related information is included in the message on the basis of at least a part of the result of the analyzing.

According to various embodiments, the notification regeneration module 1005 may regenerate the received notification (e.g., message) on the basis of the result of the processing that is performed by the notification information confirmation module 1003. If the speech related information is included in the received notification, the notification regeneration module 1005 may acquire additional information on the basis of the speech related information, and may regenerate the received notification as a notification that includes speech information on the basis of the acquired information.

According to an embodiment, the notification regeneration module 1005 may acquire additional information from a server or an external device on the basis of the speech related information that is included in the notification, and may regenerate the notification on the basis of the acquired information.

For example, the notification regeneration module 1005 may acquire the speech related information from a memory that is provided in the electronic device, another electronic device that is functionally connected to the electronic device, or a server 1013. The notification regeneration module 1005 may additionally acquire information of which speech service is possible on the basis of the contents of the notification, and may reconfigure the acquired information so that the speech service of the acquired information becomes possible.

According to various embodiments, the speech service module 1007 may perform a speech service on the basis of the notification that is regenerated by the notification regeneration module 1005. Specifically, the speech service module 1007 may convert the regenerated notification into a speech to provide the converted speech. For example, when the electronic device performs the service operation, the speech service module 1007 may operate to reproduce music related to the contents of the notification and sound effects together through a speaker 1009. For example, the speech service module 1007 may transfer speech data that is generated by converting the regenerated notification to the speaker 1009. The speaker 1009 may output a speech that corresponds to the speech data that is generated by the speech service module 1007.

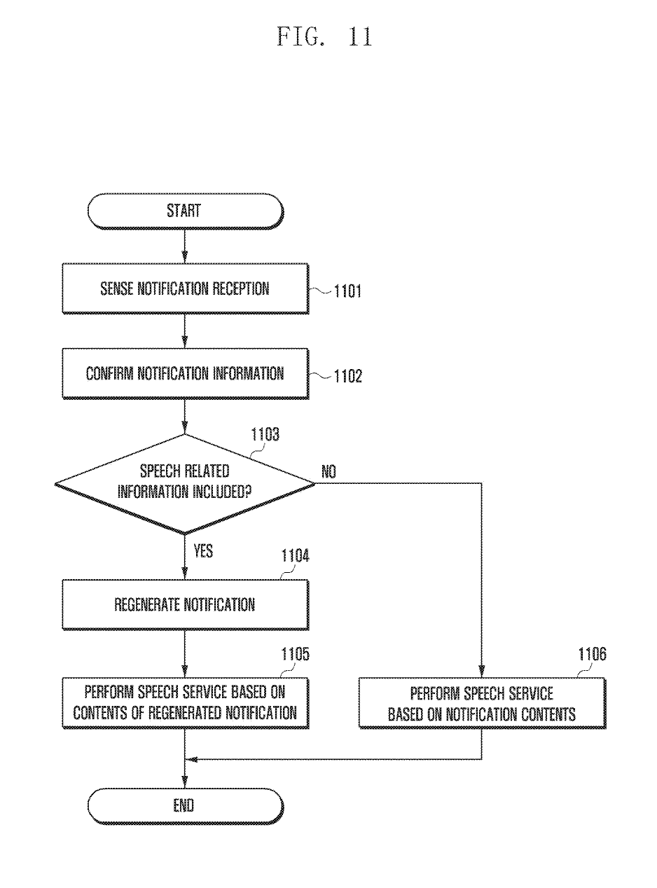

FIG. 11 is a flowchart illustrating a method for regenerating a notification in an electronic device according to an embodiment of the present disclosure.

Referring to FIG. 11, at operation 1101, the electronic device may sense reception of a notification (e.g., message). For example, the electronic device may receive the notification from at least one of the inside of the electronic device, a server that is functionally connected to the electronic device, and another electronic device.

According to various embodiments, at operation 1102, the electronic device may confirm information of the notification. According to an embodiment, the electronic device may parse the notification in order to recognize the information that is included in the received notification. For example, the electronic device may confirm various pieces of information (e.g., text, image, moving image, link, speech, and sound included in the notification, or notification related data) included in the notification. For example, the electronic device may confirm the information that is included in the notification through a notification manager or a smart assistant module.

According to various embodiments, at operation 1103, the electronic device may determine whether speech related information is included in the received notification. According to various embodiments, determination of whether the speech related information is included in the notification may be performed by the electronic device (e.g., noti manager or smart assistant module of the electronic device), an external electronic device, or a server. For example, in order to confirm the speech related information in the received notification, the electronic device may determine whether a URL is included in the received notification or whether a moving image file is included in the received notification. For example, the electronic device may confirm whether the speech related information (e.g., moving image URL or speech file) is included in the received message. For example, if a photo is included in the received message, the electronic device may determine that the speech related information is not included in the photo. If a moving image file is included in the received message, the electronic device may determine that the speech related information is included in the moving image file.

If the notification includes the speech related information as the result of the determination at operation 1103, the electronic device may regenerate the notification at operation 1104 according to various embodiments. For example, the electronic device may acquire additional information that is related to the speech on the basis of the information that is included in the notification (e.g., message), and may regenerate the notification on the basis of the acquired information. For example, the regenerated notification may include the speech information. As another example, the electronic device may extract content from at least one item (e.g., text, content, or link) that is included in the received notification or from an external resource that is related to the item, and may perform a regeneration operation for converting the notification into a speech, sound, image, video, and/or data on the basis of the received content. For example, if a moving image that is related to a cat is included in the received message, the electronic device may regenerate a message with a sentence that can be easily understood by a user, such as “cat moving image”, with respect to the related moving image. Further, if the received message includes “Dad, please buy me this” and a moving image related to a cat, the electronic device may regenerate the received message as “Dad, please buy me a cat”. According to an embodiment, the electronic device may regenerate the message using a file type, file name, image capturing time, or tag information attached to the message. The electronic device may perform Optical Character Recognition (OCR) or image search with respect to a file that is attached to the received message, and may regenerate the message on the basis of this.

According to various embodiments, at operation 1105, the electronic device may perform a speech service operation on the basis of the contents of the regenerated message. For example, the electronic device may convert a text that is included in the regenerated message into a speech through a text to speech (TTS) engine. For example, the electronic device may convert the text into the speech through an output processing module (e.g., speech synthesis module). The electronic device may output the converted speech through an output device (e.g., speaker). According to various embodiments, the electronic device may provide various functions (e.g., display of the notification through a display, providing of a tactile feedback (e.g., vibration), and the like) together with the speech service.

If the notification does not include the speech related information as the result of the determination at operation 1103, the electronic device may perform a speech service operation on the basis of the contents of the message at operation 1106. For example, the electronic device may provide the speech service through conversion of the text that is included in the received message into a speech through the TTS engine.

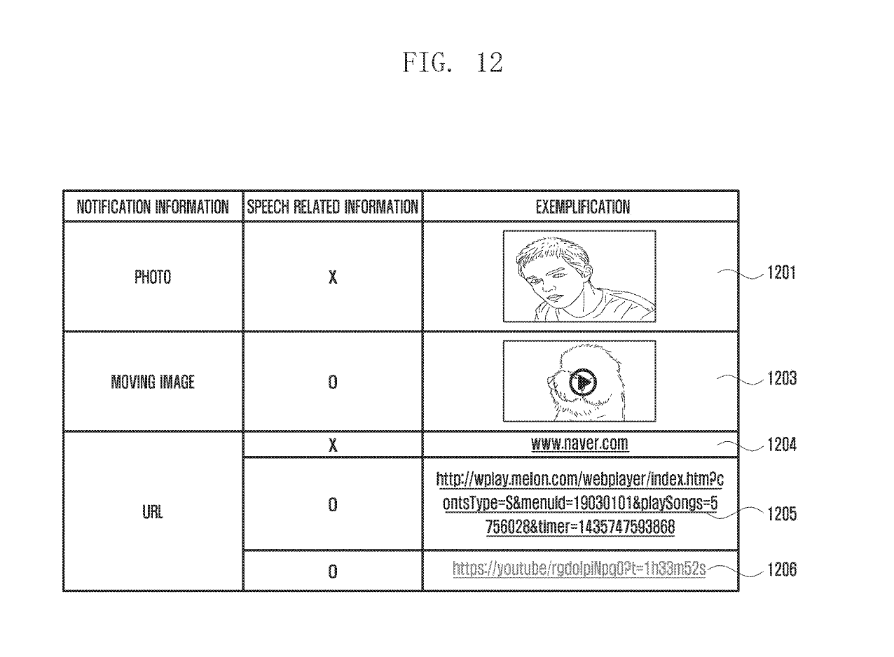

FIG. 12 is a diagram illustrating an example of a notification that is received by an electronic device according to an embodiment of the present disclosure.

According to various embodiments, a file of a photo 1201 or a moving image 1203 may be attached to a message that the electronic device has received from an outside. Further, the message that is received from the outside may include link items 1204, 1205, and 1206. According to various embodiments, the link item may include a link for a web page. For example, the link item may be a URL.

According to an embodiment, an electronic device may receive a message that includes at least one of a text, a link, and content through a communication module. A content item may include a video file, an image file, or an audio file.

According to an embodiment, if a message is received, the electronic device may parse the message to recognize the text and at least one item, and may extract or receive content from at least one item or an external resource that is related to at least one item. For example, the external resource may be a web page that corresponds to the URL, and the content may be music or a moving image.

According to an embodiment, the electronic device may convert the message into a speech, sound, an image, a video, and/or data on the basis of the parsed message and/or the extracted or received content, and may provide at least one of the speech, sound, image, video and/or data to a speaker or to at least one communication module to transmit the same to another external device. As another example, if at least one content item includes a video file or an audio file, the electronic device may extract at least a part of speech information that is included in the video file or the audio file, and may provide the extracted speech to the speaker.

For example, the electronic device may determine whether the URL is included in the main contents of the message or whether there is attached content. If the attached content is a photo 1201, the electronic device may determine that the content includes speech related information. The electronic device may determine whether the URL includes speech information from a word that is included in the URL in the message main contents. Specifically, if the URL information is included in the received message, the electronic device may determine whether the speech related information is included in the URL on the basis of a letter or a word that constitutes the URL. The electronic device may determine whether speech related information is included in the URL information through analysis of the text that constitutes the URL information. Further, the electronic device may receive a list of web sites (e.g., web page list) that provides a moving image or speech file from a server, and may determine whether the speech related information (e.g., speech file) is included in the URL information on the basis of the web page list that is provided from the server. Further, the electronic device may receive an input of a web page that provides a moving image or speech file from a user, and may determine whether the speech related information (e.g., speech file) is included in the URL information on the basis of the received web page. For example, if the URL information is an address of a portal site, the electronic device may determine that the speech related information is not included in the corresponding URL information. For example, if the URL information is www.naver.com(1204), the electronic device may determine that the speech related information is not included in the corresponding URL information. For example, the electronic device may analyze the text included in the URL information, and may determine whether the speech information is included in the URL information on the basis of at least a part of the result of analyzing the text that is included in the URL information. For example, the electronic device may determine whether the URL information corresponds to the URL address or domain information of the web site (or web page) that provides the content that includes sound (e.g., sound, speech, or moving image) on the basis of at least a part of the result of analyzing the text that is included in the URL information. For example, if the URL information is “https://youtube/rgdolpiNpq0?t=1h33m52s (1206), the electronic device may analyze the text that constitutes the URL address, and may determine that the URL information is a web page that provides a moving image from the letters “youtube” included in the URL address. As another example, if the URL information is “http://wplay.melon.com/webplayer (1205)”, the electronic device may analyze the text that constitutes the corresponding URL information, and may determine that the speech related information is included in the corresponding URL information from the letters “melon” included in the corresponding URL information.

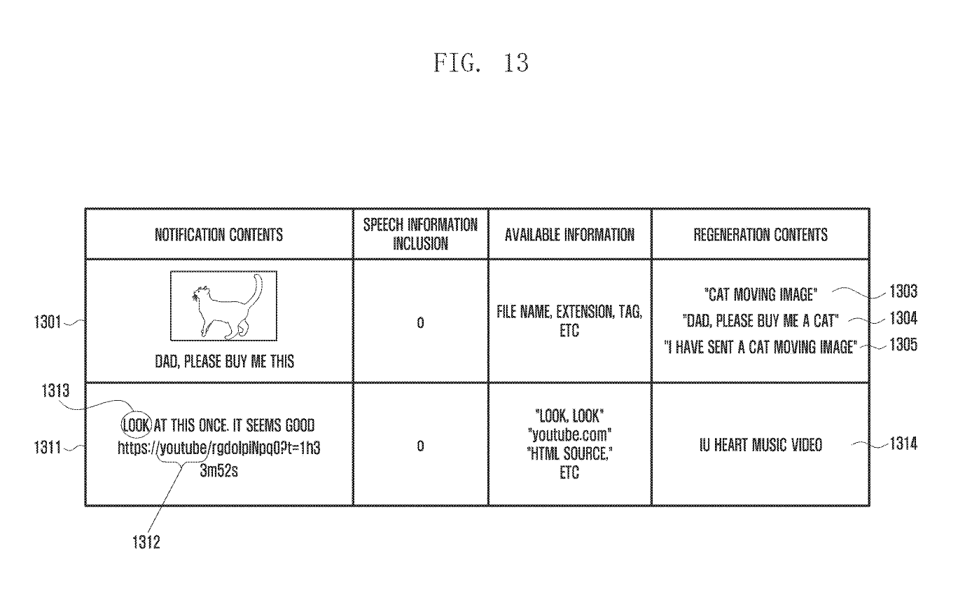

FIG. 13 is a diagram illustrating an example in which an electronic device regenerates a notification according to an embodiment of the present disclosure.

Referring to FIG. 13, if a cat moving image is attached to a notification (e.g., message) 1301, the electronic device may regenerate the notification using a file name, an extension, or tag information that is attached to the notification 1301. According to various embodiments, the electronic device may regenerate at least a part of the notification. For example, the electronic device may regenerate a link (e.g., URL) or content (e.g., photo or moving image) that is included in the received notification as at least one of a speech, sound, image, video, and data. For example, in the case of converting the notification into a speech “Cat moving image (1303)”, “Dad, please buy me a cat (1304)”, or “I have sent a cat moving image (1305), the electronic device may regenerate a message that can be easily recognized by a user on the basis of the received message. For example, if the received notification includes texts, such as “Cat moving image” and “Dad, please buy me this”, the electronic device may regenerate the notification through conversion of a part of the contents of the received notification into a different type (e.g., text), such as “Cat moving image. Dad, please buy me this”, “Dad, please buy me a cat”, or “I have sent a cat moving image. Dad, please buy me this”. According to an embodiment, the electronic device may provide the whole or a part of a speech portion of a moving image file through a speech service together with the regenerated message.

According to an embodiment, in the case of receiving a notification (e.g., message) 1311 that includes a URL, the electronic device may regenerate the notification through analysis of text information 1312 that constitutes the URL or an HTML, source that corresponds to the URL. According to an embodiment, the electronic device may regenerate the message using at least a part “look, look” of the text that is included in the received message 1311. The electronic device may regenerate the message so that the message includes at least a part of the text that is included in the received message 1311. The electronic device may regenerate the message on the basis of a URL title or a content type. For example, the electronic device may confirm that the type of the related content is a moving image and the content tile is “IU—Heart” from the URL information that is included in the received message 1311, and may regenerate the message so that the message includes the contents, such as “IU Heart music video” 1314. For example, in the case of receiving a message that includes a text “Look at this once. It seems good.” and a URL of a music video, the electronic device may generate a message, such as “Look at this once. It seems good. IU Heart music video” or “Look at IU Heart music video once. It seems good”. According to an embodiment, the electronic device may notify a user that the speech portion of the attached file can be reproduced through a speech while outputting the regenerated message 1314 through a speech. According to an embodiment, the electronic device may output related sound information (e.g., content acquired from URL information (music video)) as background music while outputting at least a part of the received message 1311 (e.g., text portion excluding the link from the message 1311).

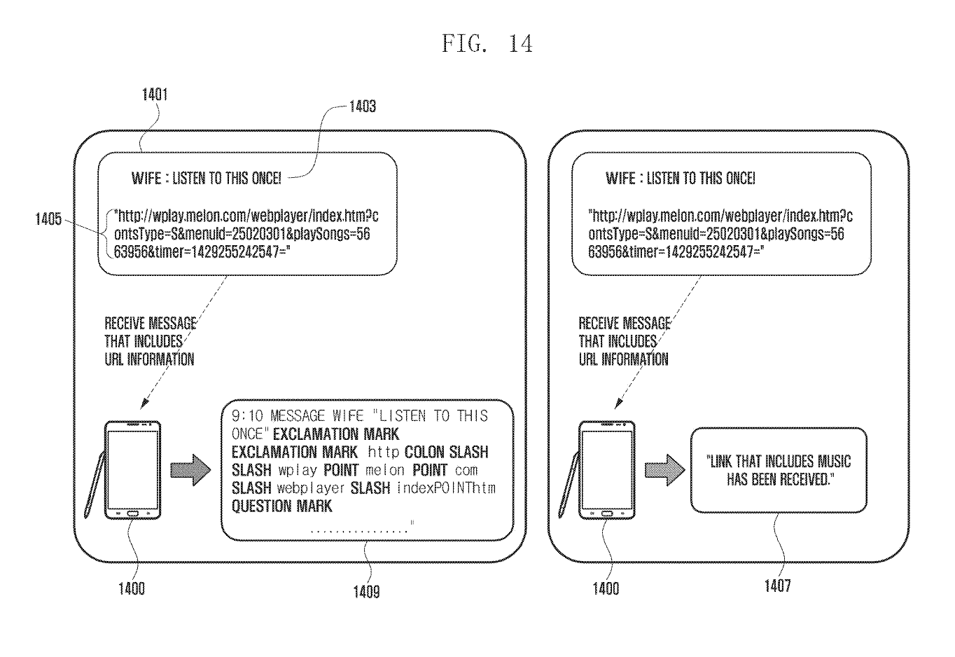

FIG. 14 is a diagram illustrating an example of a notification (e.g., message) that includes a URL according to an embodiment of the present disclosure.

According to an embodiment, if a notification (e.g., message) that includes a URL 1405 is received, the electronic device 1400 may determine whether sound related information is included in the URL 1405 that is included in the message, and if the sound related message is included, the electronic device may regenerate the notification (e.g., message) 1409 that includes speech information (e.g., speech file) through acquisition of additional information. According to various embodiments, the additional information may include sound information that corresponds to the URL information 1405 or a title of the sound information (e.g., title of music or moving image).

According to an embodiment, the electronic device may determine whether there is sound related information in the notification on the basis of at least a part of a text that is included in the notification. According to an embodiment, the electronic device may determine whether there is sound related information in the notification through syntactic/semantic analyzing of the text of the notification. For example, if at least a part of the text of the notification has a meaning related to various sounds or listening action, the electronic device may determine that the sound related information is included in the notification. For example, if a text “listen” is included in the notification, the electronic device may determine that the sound related information is included in the notification. According to an embodiment, the electronic device may analyze a syntax or meaning of the text using an intelligence module or a smart assistant module.

According to various embodiments, the electronic device may determine whether sound related information is included in the notification on the basis of dialog history according to transmission/reception of the notification (e.g., message) or information that is processed or output through a speech support function (e.g., S-voice).

According to an embodiment, the electronic device may provide a speech service on the basis of the regenerated notification. For example, the electronic device may regenerate the notification 1401 as a notification 1407 in the form of “Link that includes music has been received” through various pieces of information that can be acquired through the URL information 1405 to provide a speech service.

According to an embodiment, the regenerated message may include information related to performing of an additional operation. For example, the regenerated message may include information for executing at least one application that is included in the electronic device. For example, the regenerated information may include information for activating at least one of functions of the electronic device. For example, the electronic device may output message related sound, display the regenerated message on a display, or operate another constituent element of the electronic device while outputting the regenerated message through a speech.

For example, the electronic device may regenerate the message so that the message includes sound information that is acquired through the URL information 1405 in the form of a file, and may provide sound that corresponds to the acquired information in the form of background music together with the speech service for the URL information 1405. For example, if a music file that is related to the URL information 1405 exists, the electronic device may provide the speech service through conversion of the text portion 1403 of the message 1401 into a speech while reproducing the music that is acquired from the URL information 1405 as background music.

According to an embodiment, the regenerated message may be provided together with at least one of various output methods excluding the speech. For example, the electronic device may provide the speech service while displaying the regenerated message on the display. The electronic device may provide the speech service together with a tactile feedback (e.g., vibration) that is related to the regenerated message.

According to an embodiment, the electronic device may receive a notification (e.g., message) that includes at least one item of the text, link, and content through the communication module, identify sound related information from the notification, convert at least a part of the received notification into at least one of a speech, a sound, an image, a video, and data on the basis of the sound related information to generate a second notification, and convert the generated second notification into speech information to provide the converted speech information to the speaker.

According to an embodiment, the electronic device may acquire sound related information (e.g., speech related information) through a web page that corresponds to the link that is included in the message. For example, the sound related information may include content that can be acquired from a web site that corresponds to a URL address. According to an embodiment, the electronic device may acquire the sound related information through domain information that is included in the link that is included in the notification (e.g., message). According to an embodiment, the electronic device may also acquire the sound related information from an HTML source file of the web page that corresponds to the link that is included in the notification. For example, if the HTML source file of the web page that corresponds to the link includes the sound related information, the electronic device may acquire the sound related information that is included in the HTML source file of the web page.

According to various embodiments, if designated contents (e.g., advertisement, link (URL), and designated text) are included in the received notification (e.g., message), the electronic device may perform an operation of providing a speech service of the predetermined contents. For example, the electronic device may output a speech, such as “Notification that includes advertisement has been received”, or “Message that includes a link has been received”. According to various embodiments, the electronic device may convert the received message into a second message on the basis of at least a part of information of the received notification (e.g., message), and may provide the speech service based on the second message. For example, the electronic device may generate the second message through replacement of a specific word that is included in the received message by a predetermined sentence. If a text and URL information are included in the received message, the electronic device may convert the URL information into a predetermined sentence to provide the speech service. For example, if the contents of the message are “Have you seen this?, “http://sports.news.naver.com/main/index.nhn”, the electronic device may provide the speech service for notifying of the existence of the URL through conversion of the message into “Have you seen this?, URL is included. As another example, if a message that includes an advertisement phrase is received, the electronic device may notify the user of the contents of the corresponding advertisement through simple shortening thereof to “This is an advertisement message”.

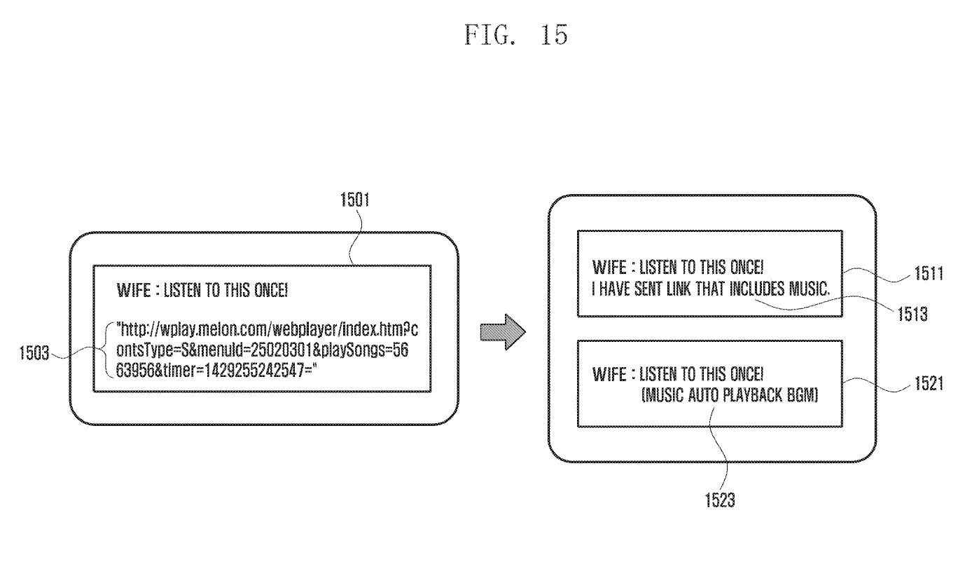

FIG. 15 is a diagram illustrating an example of a notification that is regenerated by an electronic device according to an embodiment of the present disclosure.

According to an embodiment, if a notification is received from an outside, the electronic device may regenerate the notification. For example, referring to FIG. 15, a message 1501 that is received from an outside of the electronic device and messages 1511 and 1521 regenerated by the electronic device are illustrated.

According to various embodiments of the present disclosure, the notification (e.g., message) that is received from the outside may include at least one of a text, at least one link, and content. For example, a text and URL information 1503 may be included in the message 1501 that is received from the outside. For example, the received message 1501 may include the kind of message, date and time information, receiver or sender information, or contact address information. If the notification is received, the electronic device may operate to parse the received notification, and the parsing operation may be performed through a parser module of a notification manager that is included in the electronic device. The parsing operation may include an operation of determining whether speech related information is included on the basis of information that is included in the notification. For example, the electronic device may determine whether the URL information 1503 is included in the received message 1501. If the URL is included in the received message 1501 as the result of the determination, the electronic device may determine whether speech related information is included in the message 1501 on the basis of at least a part of information related to the URL. As another example, the electronic device may search for a speech related word from the URL information, and may determine whether speech information is included in the URL information according to the result of the search. According to an embodiment, the electronic device may set a list of words that are used to determine whether the speech information is included in the URL information according to a user input, or may acquire a list of words that are used to determine whether the speech information is included in the URL information with reference to a database that is provided from a server. For example, if a word that is included in the list of words set according to the user input or a word that is included in the list of words received from the outside is included in the URL information, the electronic device may determine that the speech information is included in the URL information. For example, if a speech related word, such as “play” or “song”, is included in the URL information 1503, the electronic device may determine that the speech related information is included in the URL information. The list of speech related words may be pre-stored in a memory of the electronic device or may be received from the server. Further, the list of speech related words may be set by a user.

According to various embodiments of the present disclosure, the electronic device may analyze the contents of the notification through an intelligence module of a smart assistant module. The electronic device may parse the notification through a natural language processing module of the smart assistant module, and may determine whether information that is related to sound (e.g., speech) is included in the notification based on the parsed data. The electronic device may regenerate at least a part of the notification on the basis of at least a part of the sound related information through the natural language generation module of the smart assistant module. The electronic device may convert the notification that is received through a speech synthesis module of the smart assistant module or the regenerated notification into a speech. The electronic device may output the speech that is converted through the smart assistant module through an output device (e.g., speaker).

According to various embodiments, if the speech related information is included as the result of parsing the received notification, a notification regeneration operation may be performed. According to an embodiment, the notification regeneration operation may be performed through a notification regeneration module of a notification manager that is included in the electronic device. For example, the notification regeneration operation may be a regeneration operation to convert the notification into corresponding designated information on the basis of at least a part of the URL information that is included in the notification. For example, the designated information may be information that is included in a server that is functionally connected to the electronic device or another electronic device. For example, the electronic device may regenerate the message through conversion of the message into a predetermined sentence, for example, “We have sent a link that includes music (1513)”, on the basis of the URL information. As still another example, the notification regeneration operation may be an operation that acquires additional information based on at least a part of the notification information and regenerates the notification using at least a part of the acquired additional information. For example, the electronic device may set a sentence that will replace the URL information, or may receive information on the sentence that will replace the URL information from an external device (e.g., server). For example, the electronic device may receive a URL information related text, sound, speech, image, video, or data from the external device. The electronic device may regenerate the notification on the basis of at least a part of the received text, sound, speech, image, video, or data.

According to various embodiments of the present disclosure, the electronic device may perform a speech service operation for the regenerated notification. For example, the speech service operation may be performed through a speech service module of the notification manager. For example, the electronic device may reproduce the regenerated notification, for example, “Listen to this once!! A link that includes music has been sent to you (1513)”, through the speaker. As still another example, the electronic device may perform an additional operation on the basis of at least a part of the regenerated notification. For example, if music is linked to the URL information that is included in the notification, the electronic device may reproduce linked music as background music (1523).

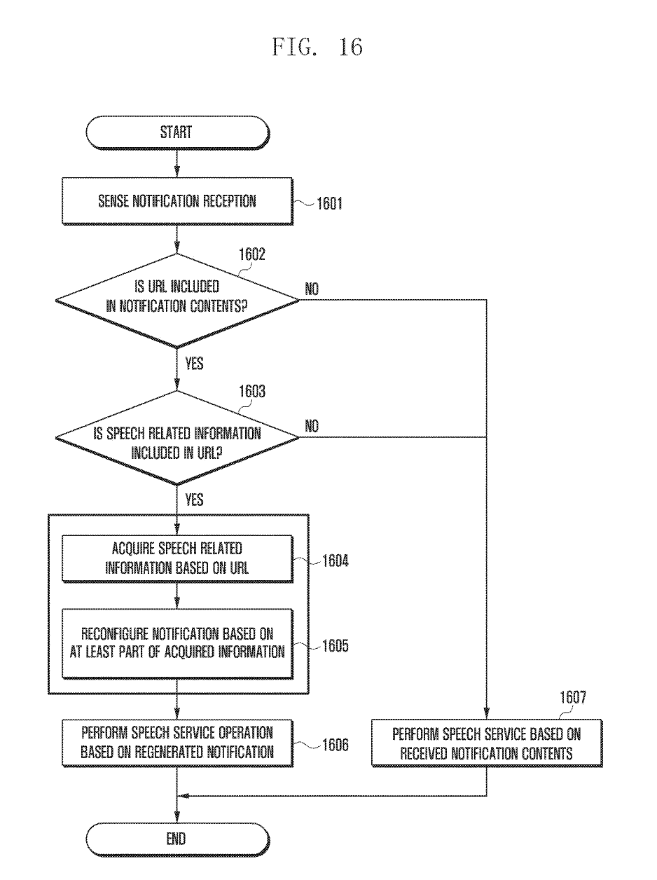

FIG. 16 is a flowchart illustrating a process of processing a notification that includes a URL according to an embodiment of the present disclosure.

Referring to FIG. 16, at operation 1601, the electronic device may operate to sense reception of a notification. For example, the electronic device may sense the notification (e.g., message) that is received from an outside of the electronic device. According to various embodiments, if the notification is received, the electronic device may further operate to confirm the state of the electronic device. For example, the electronic device may confirm whether the electronic device is in an eyes-free state. For example, the eyes-free state may be an automobile mode or a hands-free mode according to setting of the electronic device, or may be a state where a user does not watch the electronic device based on information that is acquired through a camera or a sensor provided on the electronic device. Although not illustrated in the flowchart, if the current state of the electronic device is not the eyes-free state, the electronic device may perform operation 1602. Further, the electronic device may perform operation 1602 on the basis of the user's setting.

According to various embodiments, at operation 1602, the electronic device may operate to determine whether a URL is included in the received message. For example, the operation to determine whether the URL is included may be performed through a notification manager or a smart assistant module of the electronic device, or may be performed through a server that is functionally connected to the electronic device or another electronic device. The server that is functionally connected to the electronic device or the other electronic device may include at least parts of constituent elements of the notification manager or the smart assistant module. For example, the electronic device may operate to parse the notification or may determine whether the URL is included in the notification on the basis of the result of the parsing.

If the URL is included in the contents of the notification as the result of the determination at operation 1602, the electronic device according to various embodiments, at operation 1603, may operate to determine whether information related to sound (e.g., speech) is included in the notification on the basis of the URL.

According to an embodiment, at operation 1603, the electronic device may extract or receive information from the URL or an external resource related to the URL. The electronic device may determine whether sound related information is included in the notification from the extracted or received information.

According to various embodiments, the electronic device may extract information from the URL, and may confirm speech related information on the basis of at least a part of the extracted information. For example, the electronic device may determine whether the speech related information is included in the URL information on the basis of domain (e.g., “Youtube”) information that is included in the URL information. As another example, the electronic device may confirm whether an anchor tag for notifying that speech related information is included in URL information is included, and may determine whether the speech related information is included in the URL information on the basis of at least a part of the confirmed anchor tag information. For example, the anchor tag may be automatically input to the URL information through a menu on the electronic device, or may be input to the URL information by a user input. For example, the electronic device may include an anchor tag, such as “#music” or “#P”, in the last of the URL automatically or according to the user input.

According to various embodiments, the electronic device may receive an external resource (e.g., HTML source) that is related to URL, and may determine whether speech related information is included on the basis of at least a part of information that is included in the received external resource. For example, the electronic device may determine whether speech related information is included in URL information on the basis of a player type that is included in the received HTML source.

If the information related to sound (e.g., speech) is included as the result of the determination at operation 1603, the electronic device according to various embodiments, at operation 1604, may acquire the sound related information on the basis of the URL. According to an embodiment, the electronic device may acquire the sound related information from the notification (e.g., URL included in the notification) or the external resource. For example, the electronic device may acquire the sound related information from the URL itself, or may acquire the sound related information from a web page of the URL address. According to various embodiments, if the information related to the sound (e.g., speech) is acquired at operation 1603, the electronic device may omit operation 1605. According to various embodiments, the electronic device, at operation 1605, may operate to reconfigure the notification on the basis of at least a part of the acquired information. For example, the electronic device may reconfigure the notification through conversion of at least a part of a text, link, and content that are included in the received notification into at least one of a speech, sound, image, video, and data on the basis of at least one of the acquired information. According to various embodiments, the electronic device, at operation 1606, may perform a speech service operation on the basis of the regenerated notification. For example, the electronic device may perform the speech service with respect to the contents of the regenerated message as they are, or may perform the speech service operation through correction of the regenerated message in the speech service module.

According to various embodiments, the electronic device may output the regenerated notification through at least one of an output mode of the electronic device and a device that can output the notification. For example, in the case where the speech service is provided on the basis of the regenerated message, the electronic device may search for an available display device that may be in the neighborhood of the user, and if there is such a display device in the neighborhood of the user, the electronic device may display the partial contents of the message through the display device. For example, if a URL that is related to a moving image is included in the notification, the electronic device may acquire a still image that corresponds to the moving image from the notification, an external device, or an external server, and may transmit the acquired still image to a wearable device. In this case, the wearable device that has received the still image may display the still image on the display. As described above, a case where the URL related to the moving image is included in the notification has been described, but various embodiments of the present disclosure are not limited thereto. For example, even in the case where music related URL is included in the notification, the electronic device can provide the speech service in the same manner.

If the URL is not included in the notification as the result of the determination at operation 1602, or if the speech related information is not included in the URL as the result of the determination at operation 1603, the electronic device according to various embodiments, at operation 1607, may perform the speech service on the basis of the contents of the received notification (e.g., message). For example, the electronic device may convert the received notification into a speech through a TTS engine without regenerating the received notification to provide the speech service. According to various embodiments, the electronic device may include various output modes, and may output the notification in various forms according to the output mode. For example, the electronic device may display the notification on the display while outputting the notification through a speech according to the output mode.

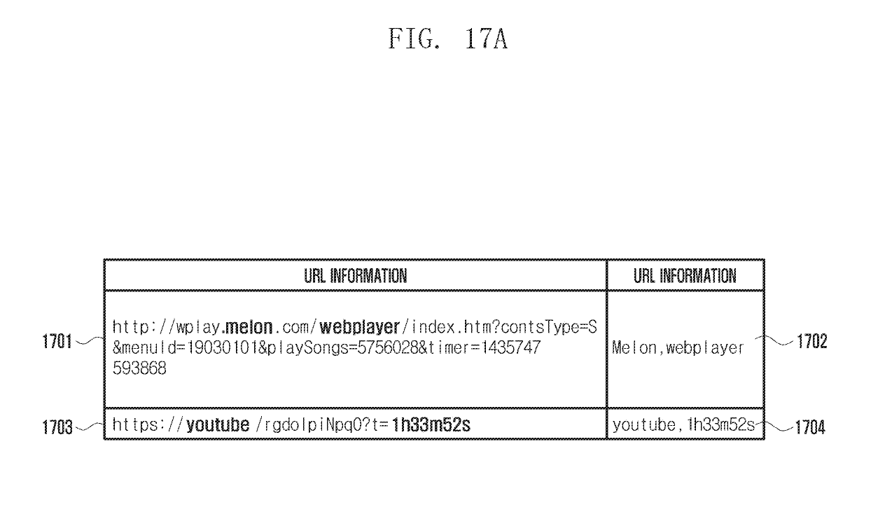

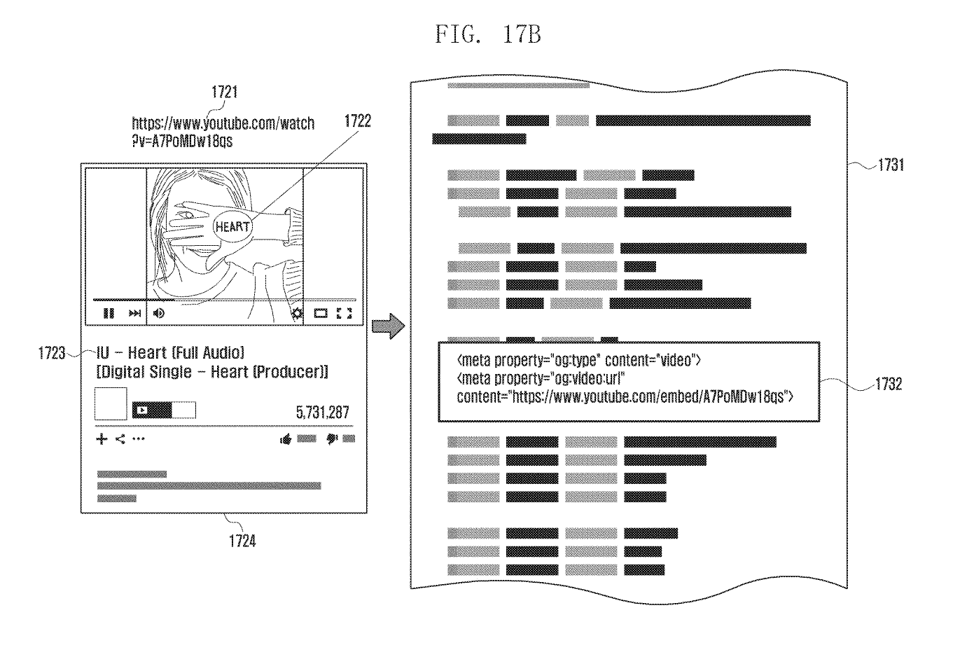

FIG. 17A is a diagram illustrating an example of additional information that an electronic device can acquire from a URL according to an embodiment of the present disclosure.

Referring to FIG. 17A, examples of URLs 1701 and 1703 are illustrated. According to an embodiment, the electronic device may acquire additional information from the URLs 1701 and 1703 themselves. The electronic device may determine whether the corresponding URL includes information related to sound (e.g., speech) on the basis of domain information that is included in the URLs 1701 and 1703. For example, the electronic device may acquire domain information “melon” from the URL 1701, and may determine that the URL 1701 includes the sound related information from the domain information. For example, the electronic device may acquire information that a content type of an address of the URL 1701 is “video”, and the title of the video is “IU Heart music video”. The electronic device may regenerate the message on the basis of the acquired content type or content title. As another example, the electronic device may acquire “webplayer” from the URL 1701, and may determine that the URL 1701 includes the sound related information from the corresponding word. As still another example, the electronic device may acquire domain information “youtube” from the URL 1703, and may determine that the URL 1703 includes the sound related information from the domain information. As still another example, the electronic device may acquire “1 h33m52s” from the URL 1703, and may determine that the corresponding URL includes information related to a moving image. As still another example, the electronic device may acquire information related to sound (e.g., speech) by connecting to the address of the URL. That is, the electronic device may regenerate the notification (e.g., message) on the basis of information that is included in an HTML, source file of a web page, and may convert the regenerated notification into a speech to provide the speech to the speaker.

FIG. 17B is a diagram illustrating an example of a web page that corresponds to a URL address according to various embodiments of the present disclosure.

Referring to FIG. 17B, a URL address 1721, a moving image 1722, a moving image title 1723, and an HTML, source 1731 are illustrated.

According to an embodiment, the electronic device may acquire additional information through accessing of a web page that corresponds to the URL. Referring to FIG. 17B, a web page 1724 that corresponds to the URL 1721 and a corresponding HTML source 1731 are illustrated. The electronic device may acquire additional information 1732 for a speech service through parsing of the HTML source 1731 that corresponds to the web page 1724. For example, the electronic device may acquire additional information that the URL 1721 is a URL that is related to a moving image from a specific word, for example, a word, such as content=“video” meta property=“og:video:url” (1732), that is included in the HTML source 1731 of the corresponding site. As another example, the electronic device may acquire additional information that the URL is “Heart” music video that is IU's new musical composition from a word, such as “<title>IU (Heart) (Full Audio) (1723)”. Further, the electronic device may acquire the moving image title 1723 as the additional information from the corresponding site.

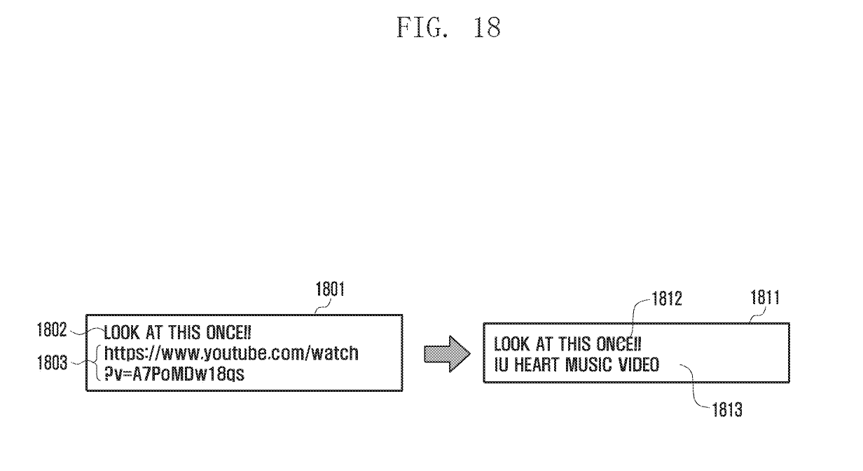

FIG. 18 is a diagram illustrating an example in which an electronic device regenerates a notification that includes a URL according to an embodiment of the present disclosure.

Referring to FIG. 18, a message 1801 that includes a URL and a regenerated message 1811 are illustrated. The message 1801 may include a text 1802 and a URL 1803. The regenerated message 1811 may include a text 1812 and a text 1813 that is converted from the URL. For example, the electronic device may regenerate a message “IU Heart music video (1813)” with respect to the URL 1803. As another example, the electronic device may regenerate a message “Link that includes music” with respect to the URL 1803.

As still another example, the electronic device may generate an audio file through extraction of only a speech portion from the corresponding moving image, and may generate a message to which the generated audio file is attached. For example, the electronic device may generate the audio file for the moving image by automatically executing an application for extracting a speech from a moving image file. As still another example, the electronic device may regenerate the message through insertion of an anchor tag into the URL. In the case of the URL that includes the anchor tag, the electronic device may not directly convert the corresponding URL into a speech, but may reconfigure the message using the content at the URL address. For example, the electronic device may regenerate the message in the form in which the anchor tag, such as #MusicPlayer, is added to the URL “https://www.youtube.com/watch?v=A7PoMDw18qs”. During the speech service, the electronic device may directly move to the web page of the URL address through the music player, and may acquire the content to provide the speech service. The anchor tag may be in an optionally designated type, such as “#p” OR “#m”, or may be in a form that include an app name, such as “MusicPlayer”.

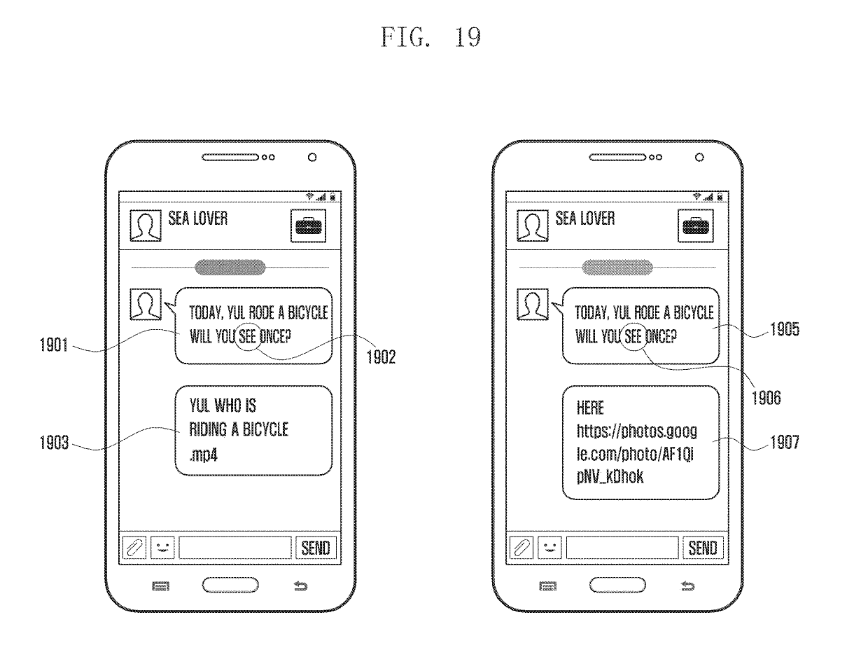

FIG. 19 is a diagram illustrating an example in which an electronic device acquires additional information on the basis of the contents of a notification and history information according to an embodiment of the present disclosure.

Referring to FIG. 19, the electronic device may display received notifications (e.g., messages) 1901, 1903, 1905, and 1907 on the screen. If the notifications (e.g., messages) 1901, 1903, 1905, and 1907 are received, the electronic device may determine whether the messages include information related to sound (e.g., speech) on the basis of the contents of the notifications and history information, acquire additional information related to sound, and regenerate the notification that includes speech information (e.g., speech file) to perform a speech service operation. According to an embodiment, in order to determine whether speech related information is included in the contents of the notification, the electronic device may analyze the contents of the notification using a linguistic feature. For example, the electronic device may extract the linguistic feature of a language that is included in the notification, and may confirm the statistical distribution of the linguistic feature through a classifier to analyze the contents of the notification.

For example, the electronic device may analyze the linguistic feature of the message by analyzing whether a morpheme that is related to the speech information, that is, a word (e.g., sound, music, song, hear, or listen) from which a speech can be analogized, is included. According to an embodiment, the electronic device may acquire additional semantic information by extracting the relationships of a specific word, such as a similar word, antonym, or hyperonym, which is included in the message using ontology. The electronic device may train a binary classifier using training data that is made on the basis of such a feature (e.g., linguistic feature or ontology) and a supervised training method (e.g., SVM, maximum entropy). Further, the electronic device may train a classifier using an unsupervised training method. If a message is received, the electronic device may extract the feature from the message, input the feature to the classifier, and execute the classifier to determine whether speech information is included in the message.

According to various embodiments, the electronic device may determine whether information related to sound (e.g., speech) is included in the received notification using a smart assistant module. According to an embodiment, the smart assistant module may analyze the contents of the received notification through an input processing module (e.g., intelligence module). The smart assistance module may parse the notification through a natural language processing module, and may determine whether information related to sound (e.g., speech) is included in the notification based on the parsed data. The smart assistant module may regenerate at least a part of the notification based on at least a part of the sound related information through an output processing module (e.g., natural language generation module). The smart assistant module may convert the notification that is received through the output processing module (e.g., speech synthesis module) or the regenerated notification into a speech. The smart assistant module (e.g., output processing module) may transmit the converted speech to an output device (e.g., speaker). The output device may output the converted speech to an outside.

For example, if messages 1901 and 1905 that include the contents of “Today, Yul rode a bicycle. Will you see once?” are received, the electronic device may extract a morpheme “see” from a sentence “Will you see once?” as shown in 1902 and 1906. The electronic device may determine that the morpheme “see” shares “feel” that is a hyperonym like “listen” through the smart assistant module. Through this, the electronic device may determine that the sound related information is included in the messages 1903 and 1907, and there is information that can be additionally acquired. For example, with respect to the message 1903, “Yul who is riding a bicycle.mp4 (1903)” and the message 1907, “https://photos.google.com/photo/AF1Qi, . . . (1907)”, the electronic device may determine that speech information is included without additional analysis, and may regenerate the message.

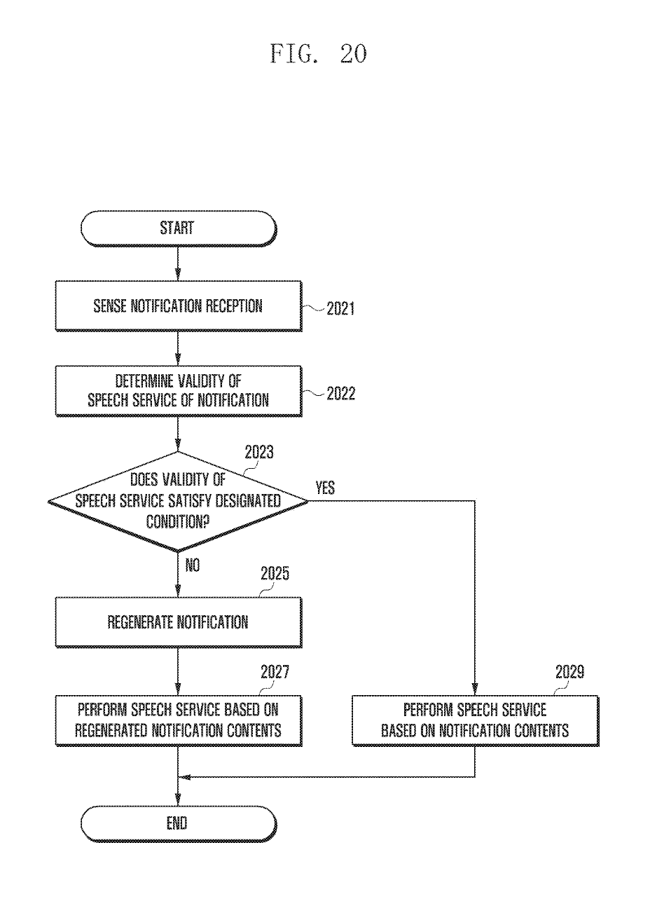

FIG. 20 is a flowchart illustrating the operation of an electronic device that provides a speech service through determination of validity of the speech service of a received notification in the case where the electronic device receives the notification according to an embodiment of the present disclosure.

Referring to FIG. 20, at operation 2021, the electronic device may operate to sense reception of a notification. For example, if a notification is received from the inside of the electronic device, an external device, or an external server, the electronic device may sense this.

According to various embodiments, at operation 2022, the electronic device may determine validity of a speech service of the notification. For example, the electronic device may determine the validity of the speech service of the notification based on at least a part of the information of the notification. For example, the validity of the speech service may mean the extent of understanding to which a user can easily understand the contents of the notification in the case where the electronic device provides the notification through a speech service (e.g., in the case where the electronic device converts the notification into a speech to output the converted speech). For example, in the case of providing the contents of the notification to the user through a speech, the electronic device may determine the validity of the speech service of the notification through determination of the extent of recognition to which the user can easily recognize the contents of the notification. For example, the electronic device may determine the validity of the speech service of the notification based on whether an item (e.g., photo or moving image) that is difficult to be converted into a speech exists in the notification, whether contents (e.g., link (e.g., URL)) that is difficult to transfer the meaning when being converted into a speech, or information on the content or link that is included in the notification.

For example, the electronic device may determine the validity of the speech service according to the type or contents of the received notification (e.g., message), or whether a link or content is included therein. For example, if an item, such as a link or content, is included in the notification, the electronic device may determine that the validity of the speech service is low. For example, even if items (e.g., link or content) having the same type are included in the notification, the electronic device may differently determine the validity of the speech service of the notification according to information related to the items included in the notification. For example, in the case of the notification that includes a link, the electronic device may differently determine the validity of the speech service in consideration of a link length, existence/nonexistence of content related to the link, and information on a URL that is related to the link.

According to an embodiment, the electronic device may determine the validity of the speech service based on at least a part of the kind of the content (e.g., image or moving image) that is included in the message. For example, if content, such as a photo or moving image, is included in the received notification, the electronic device may determine that the validity is low due to difficulty in providing speech information of the content, such as a photo or moving image.

According to an embodiment, if URL information is included in the received notification, the electronic device may determine the validity of the speech service on the basis of complexity of the URL. For example, the complexity of the URL may be determined on the basis of at least part of domain information included in the URL, and existence/nonexistence of the content (e.g., photo, music, or moving image) that is related to the URL.

According to various embodiments, the electronic device, at operation 2023, may operate to determine whether the validity of the speech service of the message satisfies a predetermined condition. For example, in the case where the electronic device determines the validity of the speech service in a plurality of operations or grades, the predetermined condition may be a condition that corresponds to the operation or grade in which the validity of the speech service of the notification has been determined. For example, in the case where the electronic device determines the validity of the speech service in three grades of “high”, “medium”, and “low”, the predetermined condition may be the condition that corresponds to high validity. According to various embodiments, the electronic device may change the determined condition according to user's setting, or the state or situation of the electronic device.

If the predetermined condition is not satisfied as the result of the determination at operation 2025, the electronic device according to various embodiments, at operation 2025, may regenerate the notification. For example, if the validity of the speech service of the received notification is medium or low, the electronic device may regenerate the notification. For example, the electronic device may regenerate at least a part of the contents of the notification in the form in which it is easy to transfer the meaning through the speech.

According to various embodiments of the present disclosure, the electronic device may acquire additional information based on the contents of the received notification, and may regenerate the notification using the acquired additional information.

According to various embodiments, the electronic device, at operation 2027, may perform a speech service operation based on the contents of the regenerated notification. In this case, the validity of the speech service of the regenerated notification may be higher than the validity of the speech service of the original notification (e.g., notification that is received by the electronic device).

If the validity satisfies the predetermined condition as the result of the determination at operation 2023, the electronic device according to various embodiments, at operation 2029, may provide a speech service based on the contents of the original message.

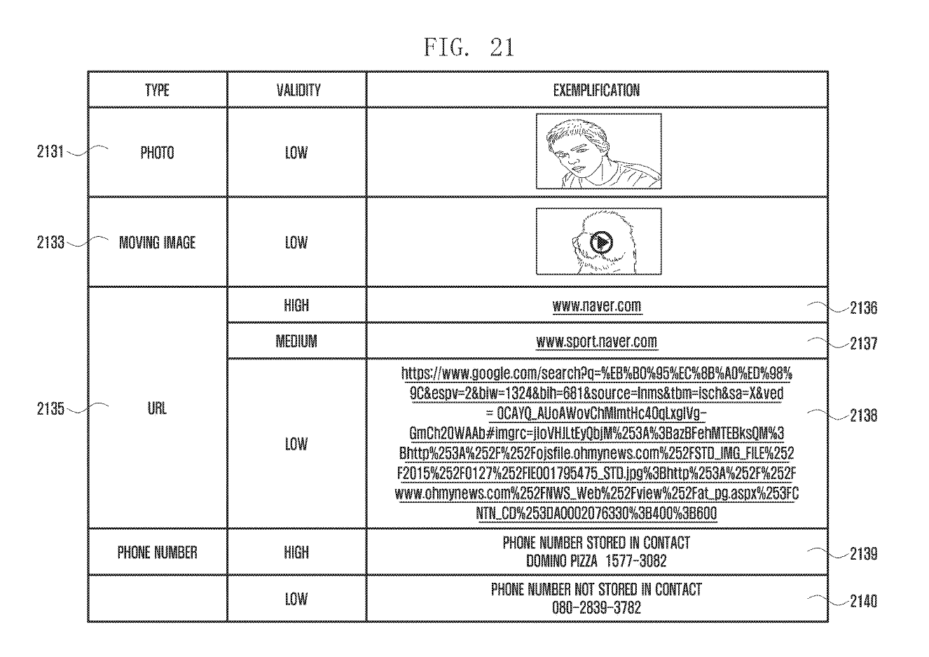

FIG. 21 is a diagram illustrating an example of the result of determination through which an electronic device determines validity of a speech service of a notification that is received by the electronic device according to an embodiment of the present disclosure.

Referring to FIG. 21, a notification (e.g., message) may include a photo 2131, a moving image 2133, a URL 2135, and phone numbers 2139 and 2140.

According to an embodiment, the electronic device may determine the validity of a speech service of a notification depending on whether content (e.g., image or moving image) is included in the notification. For example, if the notification includes a photo 2131, it means that text information that can be converted into a speech is small or conversion of the text information into the speech is meaningless, and thus the electronic device may determine that the validity of the speech service of the notification is “low”. If the notification includes a moving image 2133, it means that text information that can be converted into a speech is small or conversion of the text information into the speech is meaningless, and thus the electronic device may determine that the validity of the speech service of the notification is “low”.

According to an embodiment, if the notification includes a link (e.g., URL), the electronic device may determine the validity of the speech service of the notification based on at least a part of information of the link. For example, if the length of the URL that is included in the notification is short (2136), the electronic device may determine that the validity of the speech service of the notification is “high”. If the length of the URL that is included in the notification is medium (2137), the electronic device may determine that the validity of the speech service of the notification is “medium”. If the length of the URL is long (2138), it means that meaningless letters may be included in the URL, and the electronic device may determine that the validity of the speech service of the notification is “low”.

According to an embodiment, if the phone number 2139 is included in the notification (2139), the electronic device may determine the validity of the speech service depending on whether the phone number has been stored in a phone book. For example, if the phone number is a phone number that has been stored in the phone book (2139), the electronic device may determine that the validity of the speech service is “high”. If the phone number is not a phone number that has been stored in the phone book (2140), the electronic device may determine that the validity of the speech service is “low”.

According to various embodiments, if the notification includes at least one of a link, a speech, a sound, an image, and a video, the electronic device may determine the validity of the speech service of the notification in synthetic consideration of data or information that is included in the notification.

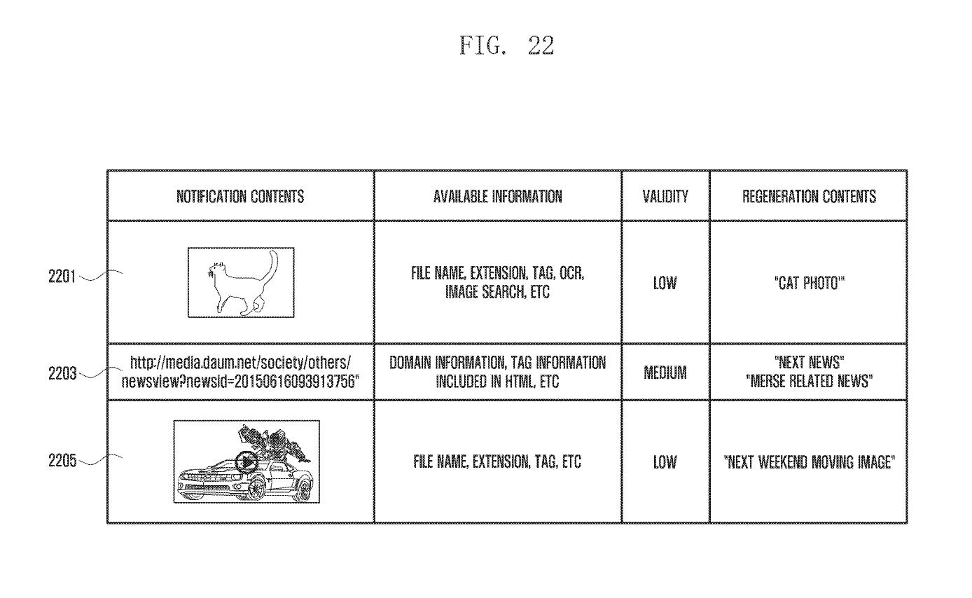

FIG. 22 is a diagram illustrating an example of a notification that is regenerated by an electronic device according to an embodiment of the present disclosure.

Referring to FIG. 22, a notification (e.g., message) that includes a photo 2201, a URL 2203, or a moving image 2205, usable information of a notification, validity of a speech service of a notification, and a regenerated message have been exemplified.

According to an embodiment, the electronic device may confirm the contents of the notification, and may determine validity of a speech service of the notification based on information (e.g., usable information) that is included in the notification. The electronic device may regenerate the notification according to the validity of the speech service.

For example, if a photo 2201 is included in the notification, the electronic device may determine that the validity of the speech service is “low”, and may regenerate the notification. The regeneration of the notification may include a case where at least a part of the notification is changed and a case where a new notification is generated.

According to an embodiment, the electronic device may acquire additional information based on the usable information, or may determine the validity of the speech service of the notification based on the usable information or the addition information. For example, the electronic device may acquire information that is obtained by converting a file name of the attached photo 2201, extension, tag information, and letters included in the photo into OCR, or may acquire the additional information on the photo through a photo search. The electronic device may determine that the validity of the speech service of the notification is “low” based on the information that is obtained by converting the file name of the attached photo 2201, extension, tag information, and letters included in the photo into the OCR. If the validity of the speech service does not satisfy a predetermined reference (e.g., if the validity of the speech service of the notification is “medium” or “low” in a state where the validity of the speech service is determined in three grades of “high”, “medium”, and “low”), the electronic device may regenerate the notification. For example, if the file name of the photo 2201 is “cat photo.jpg”, the electronic device may regenerate the message through generation of the text as the “cat photo” with respect to the photo using the text information of the file name. As still another example, if “cat” is included in the tag information that is included in the photo 2201, the electronic device may regenerate the message as the “cat photo” using the tag information. As still another example, if letters of “cat” are included in the photo image, the electronic device may acquire the letters of “cat” through the OCR process, and may regenerate the message as the “cat photo”. As still another example, the electronic device may perform an image search with respect to the photo 2201 using a key value, acquire the letters of “cat photo” as the result of the image search, and regenerate the message as the “cat photo”. As still another example, the electronic device may regenerate messages, such as “I have sent a cat photo”, “This is a message including a cat photo”, or “It is really cute”, and may provide the speech service. In this case, the electronic device may provide the speech service with a speech (e.g., tone, sex, age, or voice) that is different from that in the existing notification with respect to the regenerated portion (e.g., cat related word) while providing the speech service. For example, the electronic device may provide the speech service with a male voice with respect to the existing message portion in the regenerated notification, and may provide the speech service with a female voice with respect to the regenerated portion (e.g., cat related word), so that the user can recognize that the corresponding portion has been processed and regenerated.

According to an embodiment, if the additional information is the URL 2203, the electronic device may identify the length of the URL, and if the length of the URL is longer than a predetermined length (e.g., if the URL exceeds 20 letters), the electronic device may determine that the validity of the speech service is “low”, and may regenerate the notification based on the additional information. The predetermined value for comparison of the URL lengths may be set by a user input or may be preset by a manufacturer during manufacturing of the electronic device. The electronic device may acquire the additional information using the domain information that is included in the URL, and may regenerate the message. For example, the electronic device may acquire letters of “daum” and “news” from the URL 2203, and may regenerate the message “Daum news”. The electronic device may acquire additional information using tag information that is included in an HTML source file for a web page that corresponds to the URL, and may regenerate the notification. For example, the electronic device may analyze the HTML source file of the web page that corresponds to the URL 2203, acquire the additional information using the tag information that is included in the HTML source file, and regenerate the notification. For example, the electronic device may acquire a word “MERSE” from the tag information that is included in the HTML source file of the web page that corresponds to the URL 2203, and may regenerate a message “MERSE related news”. As another example, if a music related word is found from letters that are included in the URL, the electronic device may acquire additional information “music” using the music related word, and may regenerate the message “I have sent music related link”.

If the additional information is the moving image 2205, the electronic device may determine that the validity of the speech service is “low”, and may regenerate the notification based on the additional information. The electronic device may acquire the addition information for the moving image 2205 through the file name of the attached moving image 2205, extension, tag information, and moving image capturing date. For example, if the image capturing date of the moving image 2203 is “last weekend”, the electronic device may regenerate the notification as “Last weekend moving image” using the image capturing date.

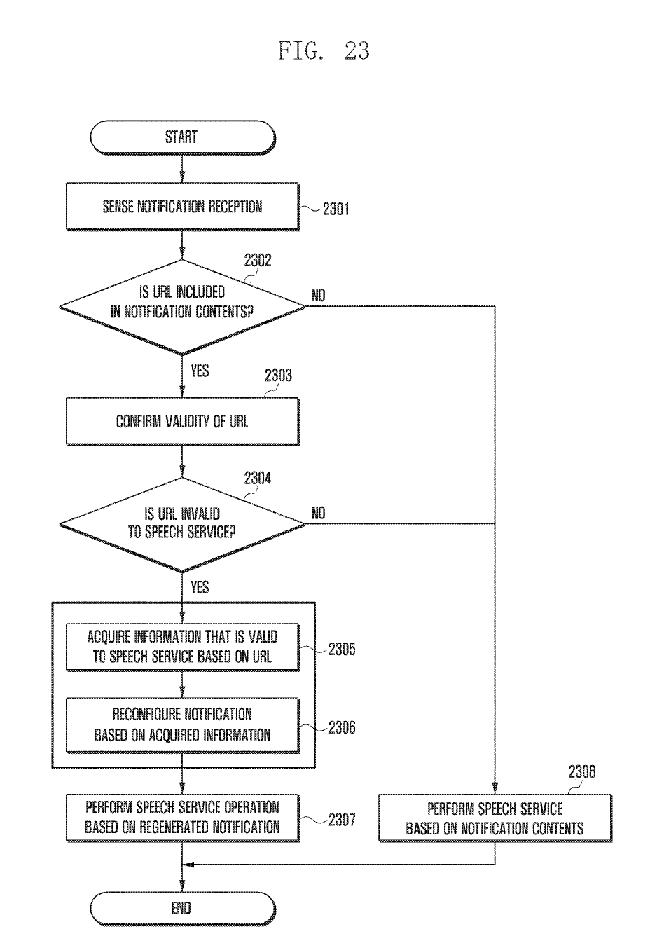

FIG. 23 is a flowchart illustrating a processing procedure when a notification that includes a URL is received according to an embodiment of the present disclosure.

According to various embodiments, at operation 2301, the electronic device may sense reception of a notification (e.g., message). According to an embodiment, the notification may include a link or content.

According to various embodiments, at operation 2302, the electronic device may determine whether a URL is included in the notification. For example, the electronic device may parse the notification, and may determine whether the link (e.g., URL) is included in the notification.

If the URL is included in the notification, the electronic device according to various embodiments, at operation 2303, may operate to confirm validity of a speech service with respect to the URL. In order to confirm the validity of the URL, the electronic device may determine the length of the URL, whether a special letter (e.g., ? or /) is included in the URL, and whether a meaningful word (e.g., word that is used as a brand) is included therein. According to an embodiment, the electronic device may measure the length of the URL through comparison of the length of the URL with a predetermined value. For example, the electronic device may determine whether the length of the URL is equal to or larger than the predetermined value or smaller than the predetermined value. The predetermined value may be set by a user input or may be set during manufacturing of the electronic device. According to an embodiment, the electronic device may set a meaningful word according to the user input, or may receive information that indicates the meaningful word from an external server.

According to an embodiment, the electronic device may determine the validity of the speech service in three grades of “high”, “medium”, and “low”. For example, the electronic device may analyze user's web page usage pattern, and may determine the validity of the speech service based on user's context information. For example, the electronic device may determine the validity of the speech service based on information of a web page that a user frequently visits. The electronic device may determine that the validity is “high” with respect to the web page (e.g., Google or Daum) that the user frequently visits.

According to various embodiments, the electronic device, at operation 2304, may determine whether the URL is invalid to the speech service. If it is determined that the URL is not valid to the speech service, the electronic device may perform operation 2305. If it is determined that the URL is valid to the speech service, the electronic device may perform operation 2308.

According to various embodiments, the electronic device, at operation 2305, may acquire information that is valid to the speech service based on the URL. For example, the electronic device may acquire information for regenerating the message based on the URL. The information that is acquired by the electronic device may be information that is included in the URL itself, or may be information that can be additionally acquired through accessing of the web page that corresponds to the URL. For example, the information that is included in the URL itself may be information that can be analogized through domain information that is included in the URL, such as “naver”, “naver sport”, “daum”, or “naver webtoon”. For example, the electronic device may acquire the additional information through processing of the domain information that is included in the URL.

According to various embodiments, the electronic device, at operation 2303, may omit operation 2305 in the case where it has acquired the information that is valid to the speech service.

According to various embodiments, the electronic device may reconfigure the message based on the acquired information at operation 2306. For example, the electronic device may reconfigure the message with title information of the web page that corresponds to the URL information that is included in the received message, or may reconfigure the message with the primary contents of the web page.

According to various embodiments, the electronic device, at operation 2307, may perform a speech service operation based on the regenerated message. For example, the electronic device may convert the contents of the reconfigured message into a speech to output the converted speech.

According to various embodiments, the electronic device, at operation 2308, may perform a speech service based on the contents of the received message. For example, the electronic device may convert the received message into a speech as it is without changing the message and may provide the converted speech to a user.

According to various embodiments, if a message is received, the electronic device may confirm the validity of the URL that is included in the message, and may regenerate the message in the case where the validity does not satisfy the designated condition.

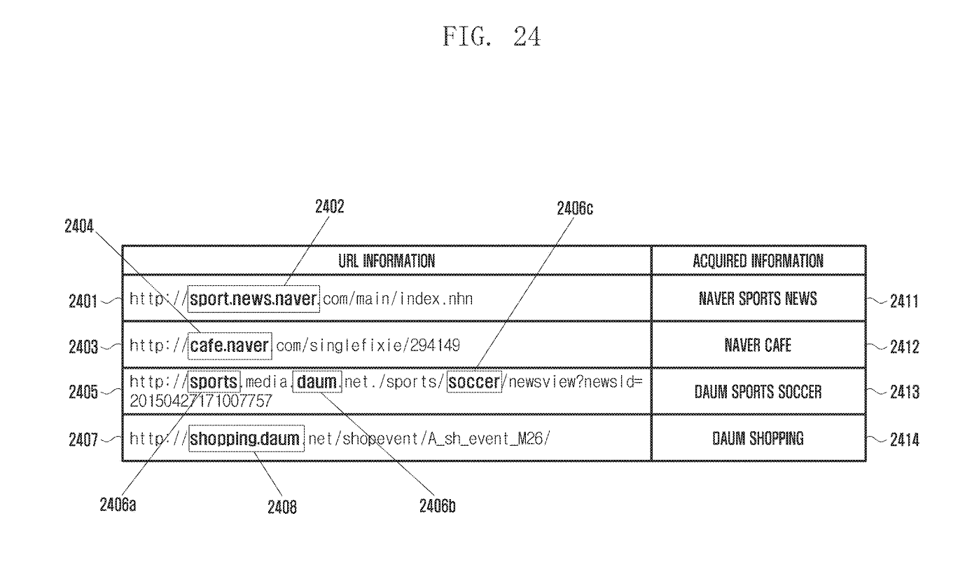

FIG. 24 is a diagram illustrating an example in which an electronic device acquires additional information using information that is included in a URL according to an embodiment of the present disclosure.

Referring to FIG. 24, the electronic device may generate additional information based on domain information 2402, 2404, 2406a, 2406b, 2406c, and 2408 included in URLs 240I, 2403, 2405, and 2407, convert the acquired additional information into a speech, and provide the speech data to a speaker or a communication module.

For example, if URL 240I is received, the electronic device may acquire domain information “sports, news, naver (2402)”, acquire additional information “naver sports news (2411)” based on the domain information, convert the additional information into a speech, and provide the speech data to the speaker or the communication module.

If URL 2403 is received, the electronic device may acquire domain information “café, naver (2404)”, generate additional information “naver café (2412)” based on the domain information, convert the additional information into a speech, and provide the speech data to the speaker or the communication module.

If URL 2405 is received, the electronic device may acquire domain information “sports, daum, soccer (2406)”, generate additional information “daum sports soccer (2413)” based on the domain information, convert the additional information into a speech, and provide the speech data to the speaker or the communication module.

If URL 2407 is received, the electronic device may acquire domain information “shopping, daum (2408)”, generate additional information “daum shopping (2414)” based on the domain information, convert the additional information into a speech, and provide the speech data to the speaker or the communication module.

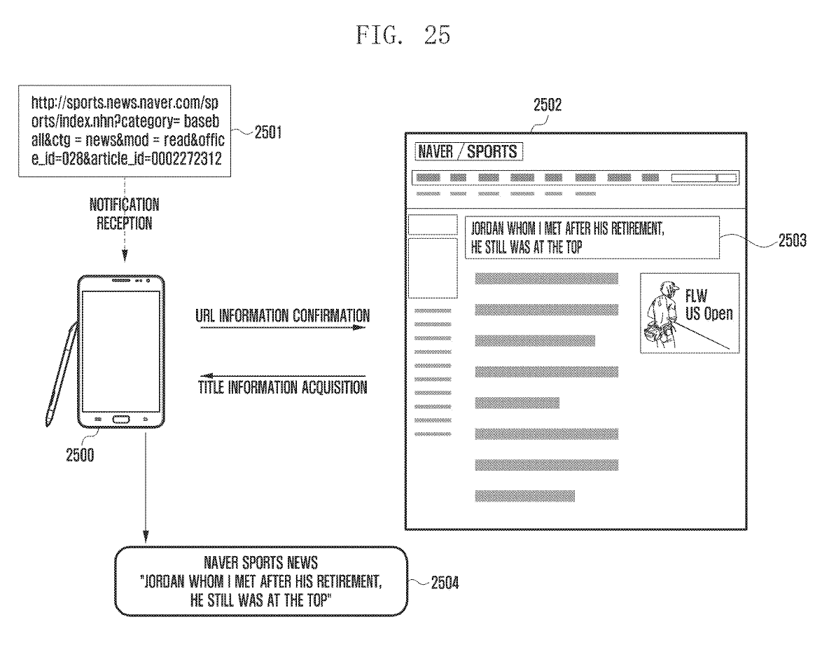

FIG. 25 is a diagram illustrating an example in which an electronic device regenerates a notification based on at least a part of information of a web page that corresponds to a URL according to an embodiment of the present disclosure.

Referring to FIG. 25, an electronic device 2500, a URL 2501 that is included in a notification (e.g., message) that is received by the electronic device, and a web page 2502 that corresponds to the URL are illustrated.

According to an embodiment, if a message that includes URL 2501 is received, the electronic device 2500 may acquire title information 2503 as addition information in the web page 2502 that corresponds to the URL 2501. The electronic device may regenerate the message 2504 using the acquired additional information, and may provide the regenerated message 2504 through the speech service. For example, the electronic device 2500 may confirm information of the web page 2502 of “naver sports” that corresponds to the URL 2501. The electronic device 2500 may acquire the title information “Jordan whom I met after his retirement, he still was at the top” 2503 that is related to the notification that is received from the web page 2502 as the additional information. The electronic device may regenerate the notification based on the information acquired from the web page. For example, the electronic device may generate a notification having the contents of “Jordan whom I met after his retirement, he still was at the top” based on at least a part of the URL information and the acquired additional information. The electronic device may convert the generated notification into a speech to output the converted speech.

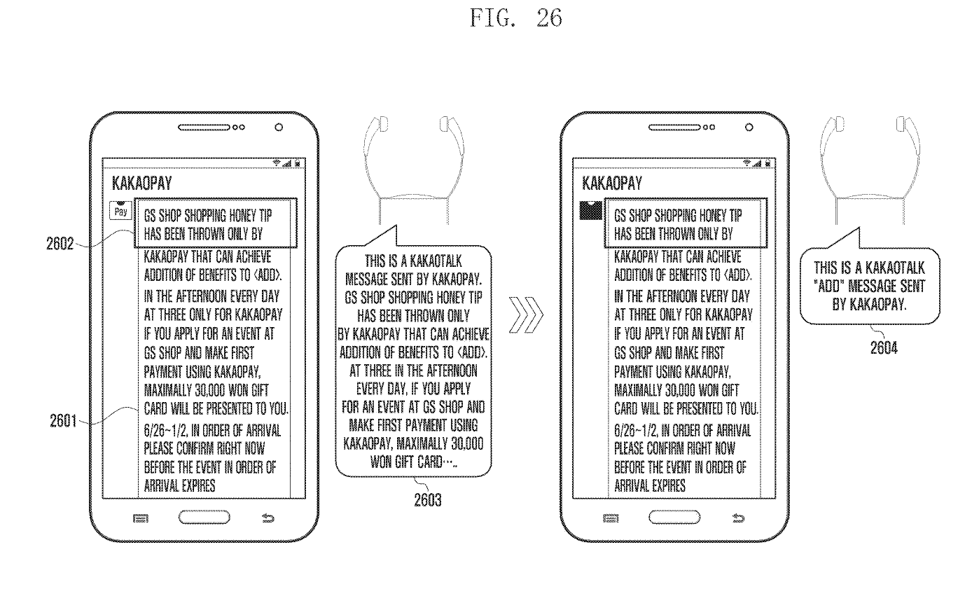

FIG. 26 is a diagram illustrating an example in which an electronic device provides a speech service that is set on the basis of the contents of a notification according to an embodiment of the present disclosure.

Referring to FIG. 26, the electronic device may determine the contents of a received notification (e.g., message), and may shorten the contents of the notification to provide the same through the speech service. For example, if a set text 2602 is included in the notification, or a set item (e.g., link or content) is included in the notification, the electronic device may provide a set speech service (e.g., set speech contents). For example, if a set text is included in the notification, or a set item (e.g., link or content) is included in the notification, the electronic device may generate the notification having the set contents, and may convert the generated notification into a speech to output the speech.

For example, if the electronic device serves an advertisement message 2601 as it is through a speech, contents that are unnecessary to a user may be included in a speech service 2603 that is provided by the electronic device. According to various embodiments of the present disclosure, if the advertisement message 2601 is received, the electronic device may shorten the advertisement contents, and may provide only core contents to the user through the speech service. For example, if advertisement is included in the contents of the received message 2601, the electronic device may provide the shortened contents 2604 through the speech service. For example, the electronic device may parse the received message 2601, and if letters “ad” is detected from the message, the electronic device may determine the received message 2601 as advertisement message, and may regenerate the advertisement message as the message 2604 that includes the shortened phrase to provide the speech service.

According to an embodiment, the electronic device may regenerate the notification using information of the content (e.g., image or video file) that is included in the received notification, and may convert the regenerated notification into a speech to output the converted speech. For example, if a photo is included in the received message, the electronic device may regenerate the message using tag information that is included in the photo to provide the speech service. If a photographing date and character information are included in the tag information that is included in the photo, the electronic device may regenerate the message using the photographing date and the character information to provide the speech service. For example, with respect to the message that includes a photo, the electronic device may regenerate the message as “A photo is included. This photo was taken together with A and B at 3:00, Mar. 27, 2015” to provide the speech service.

According to an embodiment, if the notification includes contact address information (e.g., phone number), the electronic device may reconfigure the notification through replacement of the contact address information by other information (e.g., information related to a predetermined text or contact address information), and may convert the reconfigured notification into a speech to output the converted speech.

As another example, the electronic device may receive a message that includes a phone number that has not been stored in the electronic device. According to an embodiment, if a sender of the message corresponds to a number that is not known by the user, the electronic device may reconfigure the message through acquisition of information related to the number through web search, server confirmation, or phone number providing app.

Further, the electronic device may replace the unknown phone number by other information based on the contents of the message. For example, if a message that includes the contents of “Scheduled home delivery time is 2:00 to 4:00 PM. 010-9383-3842” is received, the electronic device may reconfigure the message through replacement of the phone number “010-9383-3842” by “Home delivery driver” to provide the speech service.

Further, even in the case where an unknown word is included in the message in a similar manner as described above, the electronic device may replace the unknown word by other information based on the contents of the message to provide the speech service.

A method for operating an electronic device according to various embodiments of the present disclosure may include receiving, by the electronic device that includes at least one communication circuit, a display, and a speaker, a message that includes one or more items of a link or content through the communication circuit; parsing the message in order to recognize the one or more items; extracting or receiving content from the one or more items or from an external resource related to the one or more items; converting the message into at least one of a speech, a sound, an image, a video, and data on the basis of at least one of the parsed message and the extracted or received content; and providing the at least one of the speech, the sound, the image, the video, and the data to the speaker or the at least one communication circuit.

According to an embodiment, the message may further comprise a text, and in parsing the message, the electronic device may parse the message in order to recognize the text.

According to an embodiment, the method may further include receiving another message that includes a text using the communication circuit; and parsing the other message in order to recognize the text.

According to an embodiment, the link may include a web page related link.

According to an embodiment, one or more items of the link or the content may include a video file, an image file, or an audio file.

According to an embodiment, the method may further include extracting, if the item includes a video file or an audio file, at least a part of speech information that is included in the video file or the audio file, and providing the extracted speech to the speaker or the at least one communication circuit.

According to an embodiment, the external resource may include content which corresponds to the link and is stored in an external server.

According to an embodiment, the method may further include generating the text on the basis of domain information that is included in the link; converting the generated text into a speech; and providing the converted speech to the speaker or the at least one communication circuit.

According to an embodiment, the method may further include generating the text on the basis of information that is included in a HTML, source file for the web page; converting the generated text into a speech; and providing the converted speech to the speaker or the at least one communication circuit.

A method for operating an electronic device according to various embodiments of the present disclosure may include receiving, by the electronic device that includes at least one communication circuit, a display, and a speaker, a message that includes at least one item of a link or content and a text through the communication circuit; parsing the message in order to recognize the text and the at least one item; extract or receiving content from the at least one item or from an external resource related to the at least one item; convert the message into at least one of a speech, a sound, an image, a video, and data on the basis of at least one of the parsed message and the extracted or received content; and providing the at least one of the speech, the sound, the image, the video, and the data to the speaker or the at least one communication circuit.

Further, a method for operating an electronic device according to various embodiments of the present disclosure may include receiving, by the electronic device that includes at least one communication circuit, a display, and a speaker, a message that includes a text and at least one link or content through the communication circuit; identifying sound related information from the message, and generating sound data related to the text or the at least one link or content on the basis of the sound related information; and providing the sound data to the speaker.

According to an embodiment, the sound related information may be acquired through a web page that corresponds to the link.

According to an embodiment, the sound related information may be acquired through domain information that is included in the link.

According to an embodiment, the sound related information may be information that is included in an HTML, source file of a web page that corresponds to the link.

According to an embodiment, the method may further include converting the message into a second message on the basis of history information of the received message and providing the second message to the speaker.

A method for operating an electronic device according to various embodiments of the present disclosure may include receiving, by the electronic device that includes at least one communication circuit, a display, and a speaker, a message that includes at least one item of a text, a link, and content through the communication circuit; parsing the message in order to recognize the at least one item; extracting or receiving content from the at least one item or an external resource related to the at least one item; identifying speech related information that is included in the message through parsing of the message; converting the message into a speech, a sound, an image, a video, and/or data on the basis of at least one of the parsed message and the extracted or received content; and providing the at least one of the speech, the sound, the image, the video, and the data to the speaker or to the at least one communication circuit.

A term “module” used in the present disclosure may be a unit including a combination of at least one of, for example, hardware, software, or firmware. The “module” may be interchangeably used with a term such as a unit, logic, a logical block, a component, or a circuit. The “module” may be a minimum unit or a portion of an integrally formed component. The “module” may be a minimum unit or a portion that performs at least one function. The “module” may be mechanically or electronically implemented. For example, a “module” according to an embodiment of the present disclosure may include at least one of an ASIC chip, FPGAs, or a programmable-logic device that performs any operation known or to be developed.

According to various embodiments, at least a portion of a method (e.g., operations) or a device (e.g., modules or functions thereof) according to the present disclosure may be implemented with an instruction stored at computer-readable storage media in a form of, for example, a programming module. When the instruction is executed by at least one processor (e.g., the processor 120), the at least one processor may perform a function corresponding to the instruction. The computer-readable storage media may be, for example, the memory 130. At least a portion of the programming module may be implemented (e.g., executed) by, for example, the processor 120. At least a portion of the programming module may include, for example, a module, a program, a routine, sets of instructions, or a process that performs at least one function.

The computer-readable storage media may include magnetic media such as a hard disk, floppy disk, and magnetic tape, optical media such as a compact disc ROM (CD-ROM) and a DVD, magneto-optical media such as a floptical disk, and a hardware device, specially formed to store and perform a program instruction (e.g., a programming module), such as a ROM, a random access memory (RAM), a flash memory. Further, a program instruction may include a high-level language code that may be executed by a computer using an interpreter as well as a machine language code generated by a compiler. In order to perform operation of the present disclosure, the above-described hardware device may be formed to operate as at least one software module, and vice versa.

A module or a programming module according to the present disclosure may include at least one of the foregoing constituent elements, may omit some constituent elements, or may further include additional other constituent elements. Operations performed by a module, a programming module, or another constituent element according to the present disclosure may be executed with a sequential, parallel, repeated, or heuristic method. Further, some operations may be executed in different orders, may be omitted, or may add other operations.

According to various embodiments, in a storage medium that stores instructions, when the instructions are executed by at least one processor, the instructions are set to enable the at least one processor to perform at least one operation, wherein the at least one operation may include operation of acquiring, by a first electronic device, address information of a second electronic device and location information of at least one application to be executed by interlocking with at least the second electronic device through first short range communication with the outside; operation of connecting, by the first electronic device, second distance communication with the second electronic device based on the address information; operation of receiving, by the first electronic device, the application from the outside based on the location information; and operation of executing, by the first electronic device, the application by interlocking with the second electronic device through the second distance communication.

While the present disclosure has been shown and described with reference to various embodiments thereof, it will be understood by those skilled in the art that various changes in form and details may be made therein without departing from the spirit and scope of the present disclosure as defined in the appended claims and their equivalents.

What is claimed is:

1. An electronic device comprising:
at least one communication circuit;
a display;
a speaker;
a memory; and
a processor electrically connected to the at least one communication circuit, the display, the memory and the speaker,
wherein the processor is configured to:
receive a message that includes one or more items of a link or content through the at least one communication circuit,
parse the message in order to recognize the one or more items,
extract or receive content from the one or more items or from an external resource related to the one or more items,
convert the message into at least one of a speech, a sound, an image, a video, and data according to at least one of the parsed message and the extracted or received content, and
provide at least one of the speech, the sound, the image, the video, and the data to the speaker or the at least one communication circuit.

2. The electronic device of claim 1,
wherein the message further comprises a text, and
wherein the processor is further configured to parse the message in order to recognize the text.

3. The electronic device of claim 1, wherein the processor is further configured to:
receive another message that includes a text using the at least one communication circuit, and
parse the other message in order to recognize the text.

4. The electronic device of claim 1, wherein the link comprises a web page related link.

5. The electronic device of claim 4, wherein the one or more items of the link or the content comprises a video file, an image file, or an audio file.

6. The electronic device of claim 5, wherein the processor is further configured to:
extract, if the one or more items include the video file or the audio file, at least a part of speech information that is included in the video file or the audio file, and
provide the extracted speech to the speaker or the at least one communication circuit.

7. The electronic device of claim 4, wherein the external resource comprises content which corresponds to the link and is stored in an external server.

8. The electronic device of claim 4, wherein the processor is further configured to:
generate a text according to domain information that is included in the link,
convert the generated text into a speech, and
provide the converted speech to the speaker or the at least one communication circuit.

9. The electronic device of claim 4, wherein the processor is further configured to:
generate a text according to information that is included in a Hypertext Markup Language (HTML) source file for the web page,
convert the generated text into a speech, and
provide the converted speech to the speaker or the at least one communication circuit.

10. An electronic device comprising:
at least one communication circuit;
a display;
a speaker;
a memory; and
a processor electrically connected to the at least one communication circuit, the display, the memory and the speaker,
wherein the processor is configured to:
receive a message that includes at least one item of a link or content and a text through the at least one communication circuit,
parse the message in order to recognize the text and the at least one item,
extract or receive content from the at least one item or from an external resource related to the at least one item,
convert the message into at least one of a speech, a sound, an image, a video, and data according to at least one of the parsed message and the extracted or received content, and
provide at least one of the speech, the sound, the image, the video, and the data to the speaker or the at least one communication circuit.

11. An electronic device comprising:
at least one communication circuit;
a display;
a speaker;
a memory; and
a processor electrically connected to the at least one communication circuit, the display, the speaker, and the memory,
wherein the processor is configured to:
receive a message that includes a text and at least one link or content through the at least one communication circuit,
identify sound related information from the message,
generate sound data related to the text or the at least one link or the content according to the sound related information, and
provide the sound data to the speaker.

12. The electronic device of claim 11, wherein the sound related information is acquired through a web page that corresponds to the link.

13. The electronic device of claim 11, wherein the sound related information is acquired through domain information that is included in the link.

14. The electronic device of claim 11, wherein the sound related information is information that is included in an HTML, source file of a web page that corresponds to the link.

15. The electronic device of claim 11, wherein the processor is further configured to:
convert the message into a second message according to history information of the message, and
provide the second message to the speaker.

16. An electronic device comprising:
at least one communication circuit;
a display;
a speaker;
a memory; and
a processor electrically connected to the at least one communication circuit, the display, the speaker, and the memory,
wherein the processor is configured to:
receive a message that includes a text and at least one link or content through the at least one communication circuit,
convert the link into a text if the link is included in the message,
convert the message that includes the text into a speech, and
provide the converted speech to the speaker.

17. The electronic device of claim 16, wherein the processor is further configured to:
generate, if an advertisement is included in the message, a text that includes information related to the advertisement,
convert the text into a speech, and
provide the converted speech to the speaker.

18. A method for operating an electronic device, the method comprising:
receiving, by the electronic device that includes at least one communication circuit, a display, and a speaker, a message that includes one or more items of a link or content through the at least one communication circuit;
parsing the message in order to recognize the one or more items;
extracting or receiving content from the one or more items or from an external resource related to the one or more items;
converting the message into at least one of a speech, a sound, an image, a video, and data according to at least one of the parsed message and the extracted or received content; and
providing at least one of the speech, the sound, the image, the video, and the data to the speaker or the at least one communication circuit.

19. The method of claim 18,
wherein the message further comprises a text, and
wherein the text is recognized by the parsing of the message.

20. The method of claim 19, further comprising:
receiving another message that includes a text using the at least one communication circuit; and
parsing the other message in order to recognize the text.

21. The method of claim 18, wherein the link comprises a web page related link.

22. The method of claim 21, wherein the one or more items of the link or the content comprises a video file, an image file, or an audio file.

23. The method of claim 22, further comprising:
extracting, if the one or more items include the video file or the audio file, at least a part of speech information that is included in the video file or the audio file, and
providing the extracted speech to the speaker or the at least one communication circuit.

24. The method of claim 18, wherein the external resource comprises content which corresponds to the link and is stored in an external server.

25. The method of claim 18, further comprising:
generating a text according to domain information that is included in the link;
converting the generated text into a speech; and
providing the converted speech to the speaker or the at least one communication circuit.

26. The method of claim 21, further comprising:
generating a text according to information that is included in a Hypertext Markup Language (HTML) source file for the web page;
converting the generated text into a speech; and
providing the converted speech to the speaker or the at least one communication circuit.

27. A method for operating an electronic device, the method comprising:
receiving, by the electronic device that includes at least one communication circuit, a display, and a speaker, a message that includes at least one item of a link or content and a text through the at least one communication circuit;
parsing the message in order to recognize the text and the at least one item;
extract or receiving content from the at least one item or from an external resource related to the at least one item;
convert the message into at least one of a speech, a sound, an image, a video, and data according to at least one of the parsed message and the extracted or received content; and
providing at least one of the speech, the sound, the image, the video, and the data to the speaker or the at least one communication circuit.

28. A method for operating an electronic device, the method comprising:
receiving, by the electronic device that includes at least one communication circuit, a display, and a speaker, a message that includes a text and at least one link or content through the at least one communication circuit;
identifying sound related information from the message,
generating sound data related to the text or the at least one link or content according to the sound related information; and
providing the sound data to the speaker.

29. The method of claim 28, wherein the sound related information is acquired through a web page that corresponds to the link.

30. The method of claim 28, wherein the sound related information is acquired through domain information that is included in the link.

31. The method of claim 28, wherein the sound related information is information that is included in an HTML, source file of a web page that corresponds to the link.

32. The method of claim 28, further comprising:
converting the message into a second message according to history information of the message; and
providing the second message to the speaker.

33. A method for operating an electronic device, the method comprising:
receiving, by the electronic device that includes at least one communication circuit, a display, and a speaker, a message that includes at least one item of a text, a link, and content through the at least one communication circuit;
parsing the message in order to recognize the at least one item;
extracting or receiving content from the at least one item or an external resource related to the at least one item;
identifying speech related information that is included in the message through parsing of the message;
converting the message into a speech, a sound, an image, a video, and/or data according to at least one of the parsed message and the extracted or received content; and
providing at least one of the speech, the sound, the image, the video, and the data to the speaker or to the at least one communication circuit.

34. The method of claim 33, further comprising:
determining a length of the link to confirm validity of a speech service with respect to the link.

35. The method of claim 34, wherein the determining of the length of the link comprises:
comparing the length of the link to a predetermined value; and
determining whether the length of the link is equal to or larger than the predetermined value or smaller than the predetermined value.
